(19) United States
(12) Patent Application Publication
(10) Pub. No.: US 2024/0051317 A1
(43) Pub. Date: Feb. 15, 2024

(54) Crafting Apparatus Support Member

(71) Applicant: Cricut, Inc., South Jordan, UT (US)

(72) Inventors: Kyle Kenneth JOHNSON, Eagle Mountain, UT (US); Grayson Stopp, San Francisco, CA (US); Yung T seng Chen, San Francisco, CA (US); Ryun Bates Noble, Salt Lake City, UT (US); Joel Thomas Ruiter, Ada, MI (US)

(73) Assignee: Cricut, Inc., South Jordan, UT (US)

(21) Appl. No.: 18/260,169

(22) PCT Filed: Jan. 27, 2022
(86) PCT No.: PCT/US2022/014062

§ 371 Date: Jun. 30, 2023

Related U.S. Application Data
(60) Provisional application No. 63/142,488, filed on Jan. 27, 2021.

(51) Int. Cl. B41J 29/02; B41J 13/10

(52) U.S. Cl. CPC B41J 29/02; B41J 13/106

(57) ABSTRACT

A crafting apparatus support member (10, 100) is configured to support a crafting apparatus (300) and a lower surface (324) of the crafting apparatus includes one or more boss-receiving cavities (325). The crafting apparatus support member includes a substantially planar body portion (12, 112) and one or more crafting apparatus interface portions (36, 136). The substantially planar body portion includes an upper surface (14, 114), a lower surface (16, 116) and a side surface (18, 118) connecting the upper surface (14, 114) to the lower surface (16, 116). The one or more crafting apparatus interface portions include a boss portion (38, 138) extending from the upper surface of the substantially planar body portion that are configured to be interfaced with the one or more boss-receiving cavities.

### CROSS-REFERENCE TO RELATED APPLICATIONS

This application claims priority under 35 U.S.C. § 119(e) to U.S. Patent Application No. 63/142,488 filed Jan. 27, 2021, the disclosure of which is considered part of the disclosure of this application and is hereby incorporated by reference in its entirety.

### TECHNICAL FIELD

The present disclosure relates generally to electronic cutting systems and methods of use. In particular, the present disclosure relates to a crafting apparatus support member and methods for operating the same.

### BACKGROUND

This section provides background information related to the present disclosure and is not necessarily prior art.

While known crafting devices have proven to be acceptable for various applications, such devices are nevertheless susceptible to improvements that may enhance their overall performance and cost. Therefore, a need exists to develop improved crafting devices that advance the art.

### SUMMARY

One aspect of the disclosure provides a crafting apparatus support member that supports a crafting apparatus. A lower surface of the crafting apparatus includes one or more boss-receiving cavities. The crafting apparatus support member includes a: substantially planar body portion; and one or more crafting apparatus interface portions. The substantially planar body portion includes an upper surface, a lower surface, and a side surface, connecting the upper surface to the lower surface. The one or more crafting apparatus interface portions include a boss portion extending from the upper surface of the substantially planar body portion that are configured to be interfaced with the one or more boss-receiving cavities of the crafting apparatus.

Implementations of the disclosure may include one or more of the following optional features. In some implementations, the crafting apparatus support member includes a workpiece retainer assembly connected to the upper surface of the substantially planar body portion. The workpiece retainer assembly includes a pair of rod members and a pair of bracket members. The pair of rod members include a first rod member and a second rod member that a spaced apart by a distance for forming a workpiece-material-receiving-gap. A pair of bracket members support the pair of rod members away from the upper surface of the substantially planar body portion at a height. The pair of bracket members include a first bracket member and a second bracket member.

In some examples, the lower surface of the substantially planar body portion is configured to be supported by a table. In other examples, the side surface of the substantially planar body portion is configured to be connected to a wall. In yet other examples, the lower surface of the substantially planar body portion is configured to be supported by a crafting apparatus support member management sub-assembly.

In some implementations, the crafting apparatus support member management sub-assembly includes a pair of leg assemblies defined by a first leg assembly and a second leg assembly. In other implementations, the crafting apparatus support member management sub-assembly includes one or more catch basket assemblies connected to one or both of the first leg assembly and the second leg assembly. The one or more catch basket assemblies includes a body of anti-static material.

In other examples, the crafting apparatus includes a working surface angle that defines a working three dimensional Cartesian coordinate system. The upper surface of the substantially planar body portion defines a non-working three dimensional Cartesian coordinate system that is angularly offset from the working surface angle of the crafting apparatus.

Another aspect of the disclosure provides a crafting apparatus assembly. The crafting apparatus assembly includes a: crafting apparatus support member; and a crafting apparatus. The crafting apparatus support member includes a substantially planar body portion having an upper surface, a lower surface, and a side surface connecting the upper surface to the lower surface. One or more crafting apparatus interface portions having a boss portion extending from the upper surface of the substantially planar body portion. The crafting apparatus is supported by the crafting apparatus support member. A lower surface of the crafting apparatus include one or more boss-receiving cavities. The boss portion of the one or more crafting apparatus interface portions is configured to be interfaced with the one or more boss-receiving cavities of the crafting apparatus.

This aspect may include one or more of the following optional features. In some examples, the crafting apparatus includes a working surface angle that defines a working three dimensional Cartesian coordinate system. The upper surface of the substantially planar body portion defines a non-working three dimensional Cartesian coordinate system that is angularly offset from the working surface angle of the crafting apparatus.

In some examples, the crafting apparatus assembly further includes a workpiece retainer assembly connected to the upper surface of the substantially planar body portion. The workpiece retainer assembly includes a pair of rod members and a pair of bracket members. The pair of rod members include a first rod member and a second rod member that a spaced apart by a distance for forming a workpiece-material-receiving-gap. The pair of bracket members that support the pair of rod members away from the upper surface of the substantially planar body portion at a height. The pair of bracket members include a first bracket member and a second bracket member.

In some implementations, the lower surface of the substantially planar body portion is configured to be supported by a table. In other configurations, the side surface of the substantially planar body portion is configured to be connected to a wall. In yet other configurations, the lower surface of the substantially planar body portion is configured to be supported by a crafting apparatus support member management sub-assembly.

In other examples, the crafting apparatus support member management sub-assembly includes a pair of leg assemblies defined by a first leg assembly and a second leg assembly. In other implementations, the crafting apparatus support member management sub-assembly also includes one or more catch basket assemblies connected to one or both of the first leg assembly and the second leg assembly. The one or more catch basket assemblies include a body of anti-static material.

The details of one or more implementations of the disclosure are set forth in the accompanying drawings and the description below. Other aspects, features, and advantages will be apparent from the description and drawings, and from the claims.

### DESCRIPTION OF DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a top front perspective view of an exemplary crafting apparatus support member.

FIG. 2 is an enlarged portion of the crafting apparatus support member of FIG. 1.

FIG. 3 is another enlarged portion of the crafting apparatus support member of FIG. 1.

FIG. 4 is an exploded side view of a crafting apparatus assembly including two or more of: the crafting apparatus support member of FIG. 1; a crafting apparatus; a roll of workpiece material; and a support portion positioned upon an underlying ground surface or floor.

FIG. 5A is an enlarged side view of FIG. 4 showing the crafting apparatus arranged above and not connected to a cross-sectional side view of the one or more crafting apparatus interface portions of the crafting apparatus support member of FIGS. 2 and 3.

FIG. 5B is another enlarged side view according FIG. 5A showing the crafting apparatus arranged upon and partially connected to the one or more crafting apparatus interface portions of the crafting apparatus support member.

FIG. 5C is another enlarged side view according FIG. 5B showing the crafting apparatus arranged upon and selectively removably-connected to the one or more crafting apparatus interface portions of the crafting apparatus support member.

FIG. 6A is an assembled side view of a crafting apparatus assembly according to FIG. 5C including: the crafting apparatus support member; the crafting apparatus; the roll of workpiece material rotatably-supported by the crafting apparatus support member; and the support portion.

FIG. 6B is an assembled side view of a crafting apparatus assembly according to FIG. 5C including: the crafting apparatus support member; the crafting apparatus; the roll of workpiece material rotatably-supported by the crafting apparatus support member; and the support portion.

FIG. 7 is another side view of the crafting apparatus support member and the crafting apparatus according to FIG. 6A illustrating a downstream workpiece support member of the crafting apparatus arranged in a deployed orientation and an upstream workpiece support member of the crafting apparatus arranged in a deployed orientation.

FIG. 8 is a front perspective view of the crafting apparatus support member and the crafting apparatus according to FIGS. 5C and 6.

FIG. 9 is a rear perspective view of the crafting apparatus support member and the crafting apparatus according to FIGS. 5C and 6.

FIG. 10 is a top rear perspective view of an exemplary crafting apparatus support member.

FIG. 11 is an enlarged portion of the crafting apparatus support member of FIG. 10.

FIG. 12 is another enlarged portion of the crafting apparatus support member of FIG. 10.

FIG. 13 is an exploded side view of a crafting apparatus assembly including: a crafting apparatus; a roll workpiece material; and the crafting apparatus support member of FIG. 10 positioned upon an underlying ground surface or floor.

FIG. 14A is an enlarged side view of FIG. 13 showing the crafting apparatus arranged above and not connected to a cross-sectional view of the one or more crafting apparatus interface portions of the crafting apparatus support member of FIG. 13.

FIG. 14B is another enlarged side view according FIG. 14A showing the crafting apparatus arranged upon and partially connected to the one or more crafting apparatus interface portions of the crafting apparatus support member.

FIG. 14C is another enlarged side view according FIG. 14B showing the crafting apparatus arranged upon and selectively removably-connected to the one or more crafting apparatus interface portions of the crafting apparatus support member.

FIG. 15 is an assembled side view of the crafting apparatus assembly according to FIG. 14C including: the crafting apparatus support member; the crafting apparatus; and the roll of workpiece material rotatably-supported by the crafting apparatus support member.

FIG. 16 is another side view of the crafting apparatus support member and the crafting apparatus according to FIG. 15 illustrating a downstream workpiece support member of the crafting apparatus arranged in a deployed orientation and an upstream workpiece support member of the crafting apparatus arranged in a deployed orientation.

FIG. 17 is a front perspective view of the crafting apparatus support member and the crafting apparatus according to FIGS. 14C and 15.

FIG. 18 is a rear perspective view of the crafting apparatus support member and the crafting apparatus according to FIGS. 14C and 15.

FIG. 19 is a view of a plurality of components of the crafting apparatus support member of FIG. 10 arranged in a disassembled state.

FIG. 20 is a perspective view of a portion of a lower surface of a substantially planar body of the crafting apparatus support member of FIG. 10 including a first leg assembly base member interface and a portion of a first leg assembly that is configured for attachment to the first leg assembly base member interface.

FIG. 21 is a perspective view of another portion of the lower surface of the substantially planar body of the crafting apparatus support member of FIG. 20 including a second leg assembly base member interface and a portion of a second leg assembly that is configured for attachment to the second leg assembly base member interface.

FIG. 22 is an enlarged view of a portion of a crafting apparatus support member management sub-assembly of the crafting apparatus support member according to FIG. 10.

FIG. 23 is an enlarged view of a portion of a crafting apparatus support member management sub-assembly of the crafting apparatus support member according to FIG. 10.

FIG. 24 is another enlarged view of a portion of a crafting apparatus support member management sub-assembly of the crafting apparatus support member according to FIG. 10.

FIG. 25 is another enlarged view of a portion of a crafting apparatus support member management sub-assembly of the crafting apparatus support member according to FIG. 10.

FIG. 26 is another enlarged view of a portion of a crafting apparatus support member management sub-assembly of the crafting apparatus support member according to FIG. 10.

FIG. 27 is a front, bottom perspective view of the crafting apparatus of FIG. 4-9 or 13-18.

FIGS. 27A-27C are top right perspective views of the crafting apparatus of FIG. 25 conducting work on workpiece material derived from the roll of workpiece material seen at FIGS. 4, 6A-7, 13, 15-16.

FIG. 28 is a top right perspective view of the crafting apparatus of FIG. 27 and a preconfigured workpiece (that is not derived from the roll of workpiece material arranged upon the roll of workpiece material of FIGS. 4, 6A-7, 13, 15-16) arranged upon a workpiece support mat that is supported by: a working surface of the crafting apparatus; the downstream workpiece support member arranged in the deployed orientation of FIGS. 7 and 16; and the upstream workpiece support member arranged in the deployed orientation of FIGS. 7 and 16.

FIG. 29 is a schematic view of an example computing device that may be used to implement the systems and methods described herein.

Corresponding reference numerals indicate corresponding parts throughout the drawings.

### DETAILED DESCRIPTION

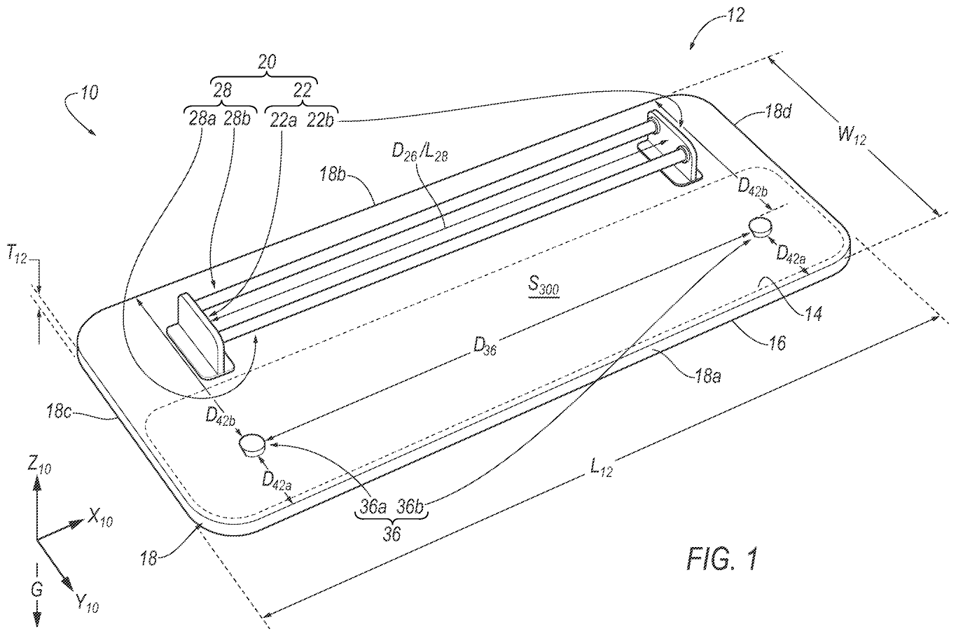

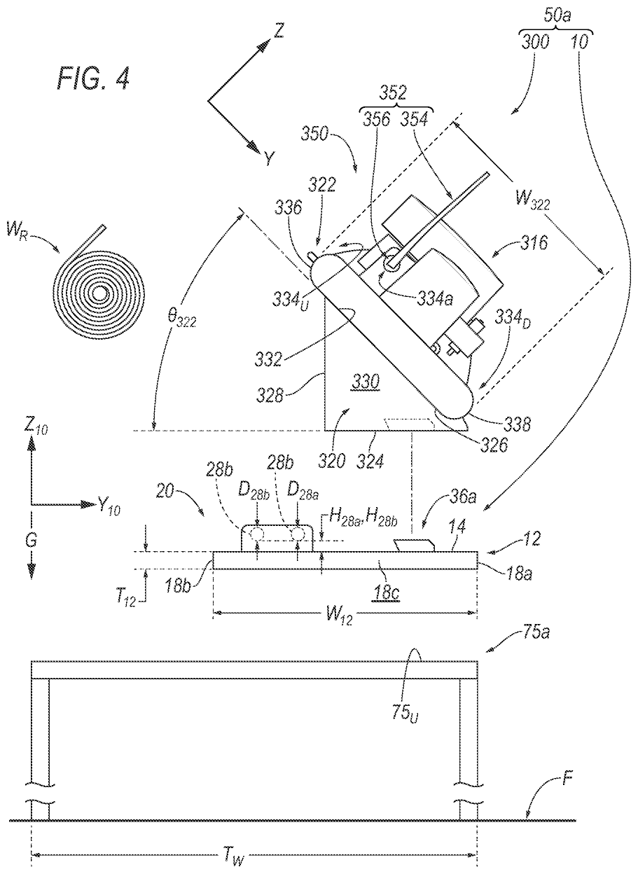

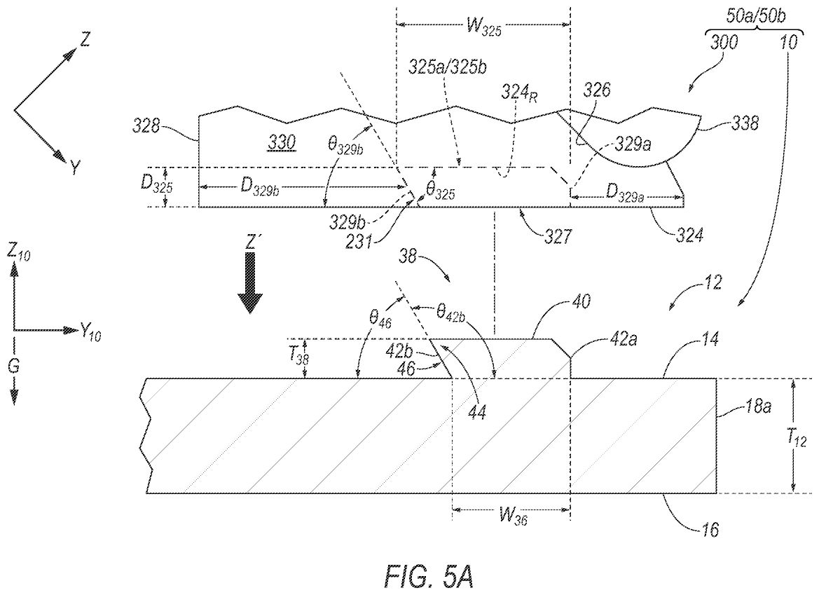

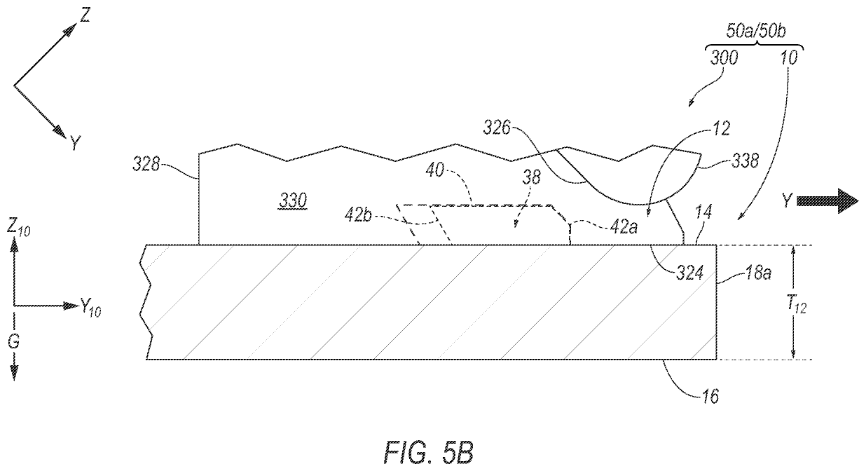

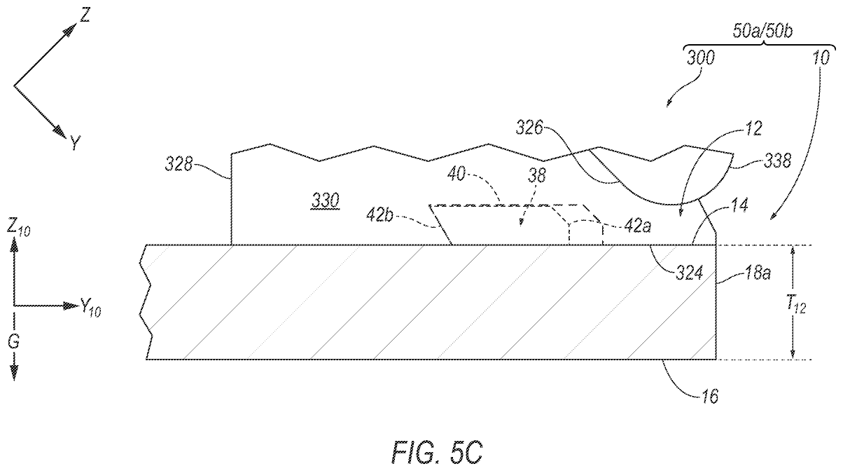

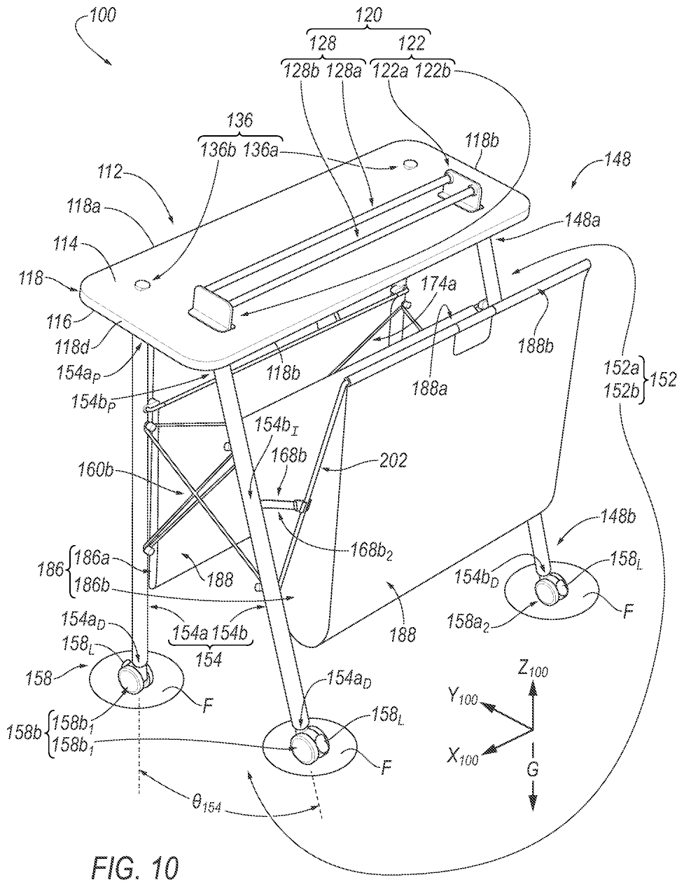

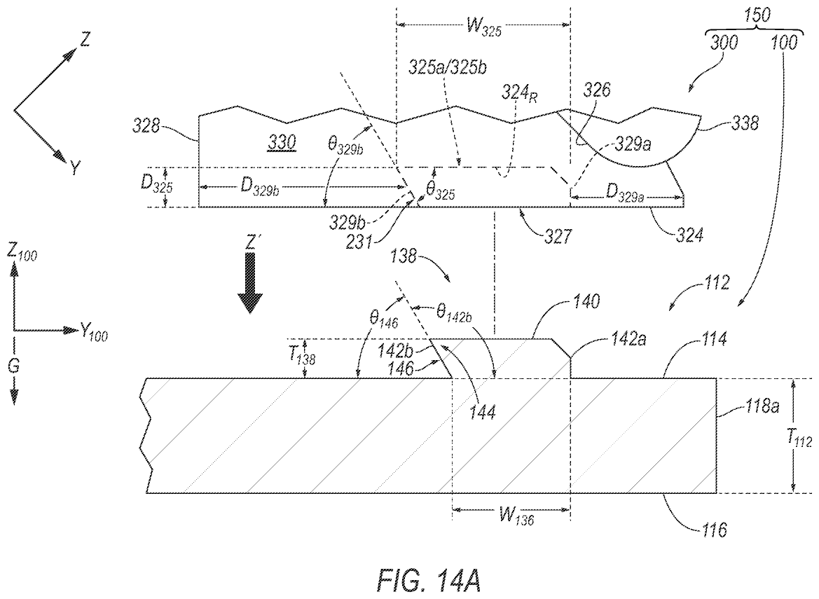

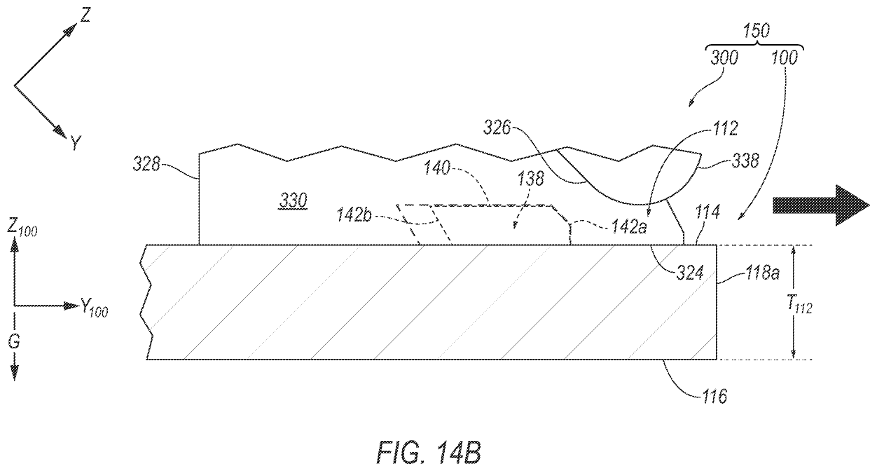

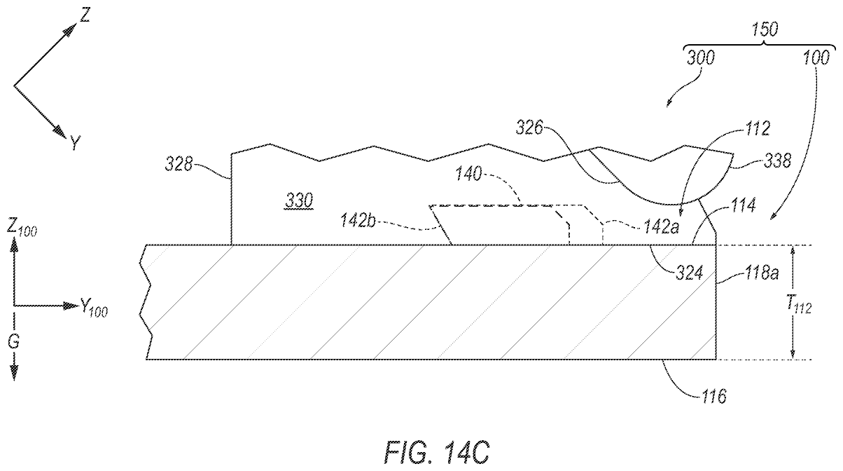

Embodiments of the present disclosure relate generally to crafting apparatus support members that are seen generally at 10 in FIGS. 1-9 and at 100 in FIGS. 10-19. Other embodiments of the present disclosure also include a crafting apparatus 300 (as seen at, e.g., FIGS. 4-9, 13-18, and 27-28) configured for selective removable-connection (see, e.g., FIGS. 5A-5C or FIGS. 14A-14C) with either of the crafting apparatus support members 10, 100. Aspects of the crafting apparatus 300 not described in the present disclosure are described in PCT application PCT/US2022/014014, filed on Jan. 27, 2022, titled “Crafting Apparatus”, the disclosure of which is considered part of the disclosure of this application and is hereby incorporated by reference in its entirety.

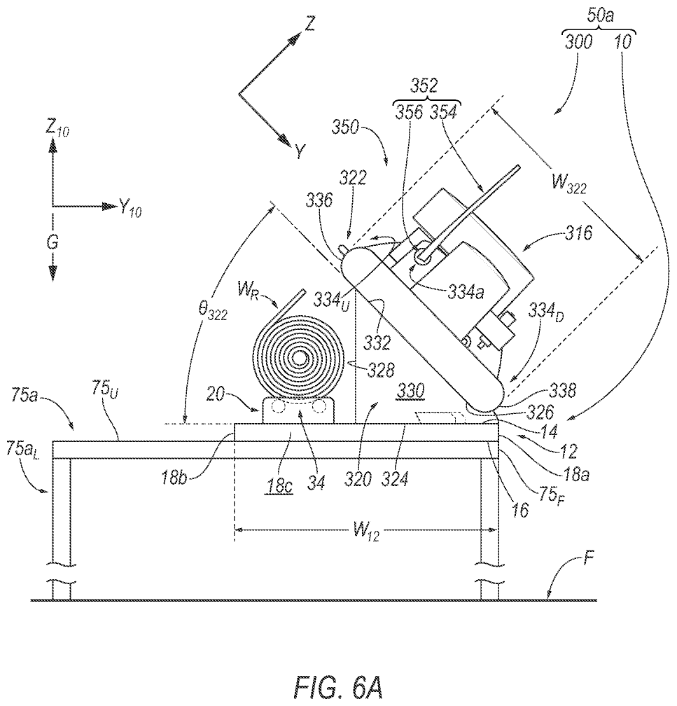

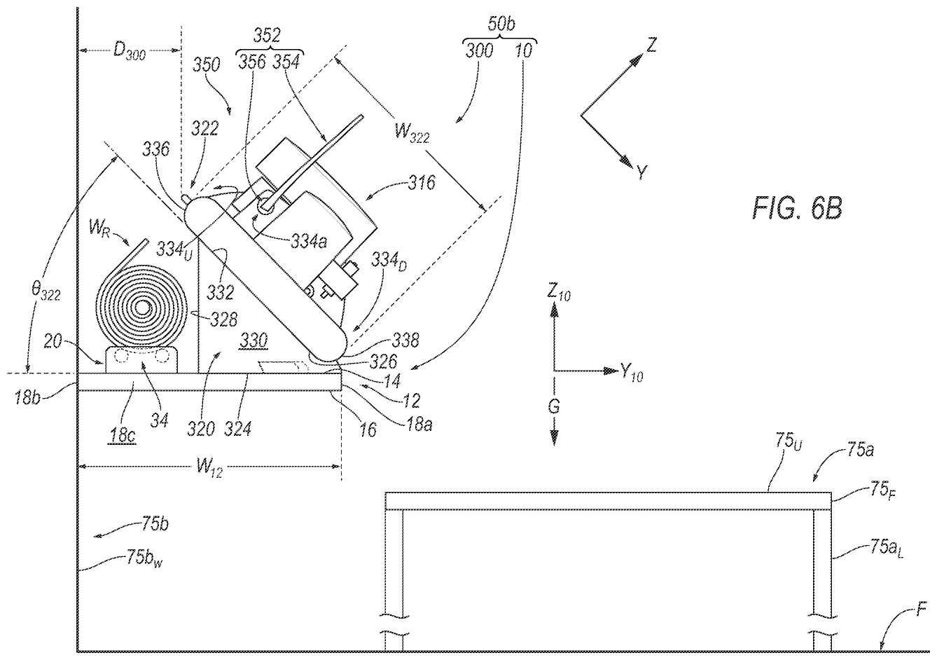

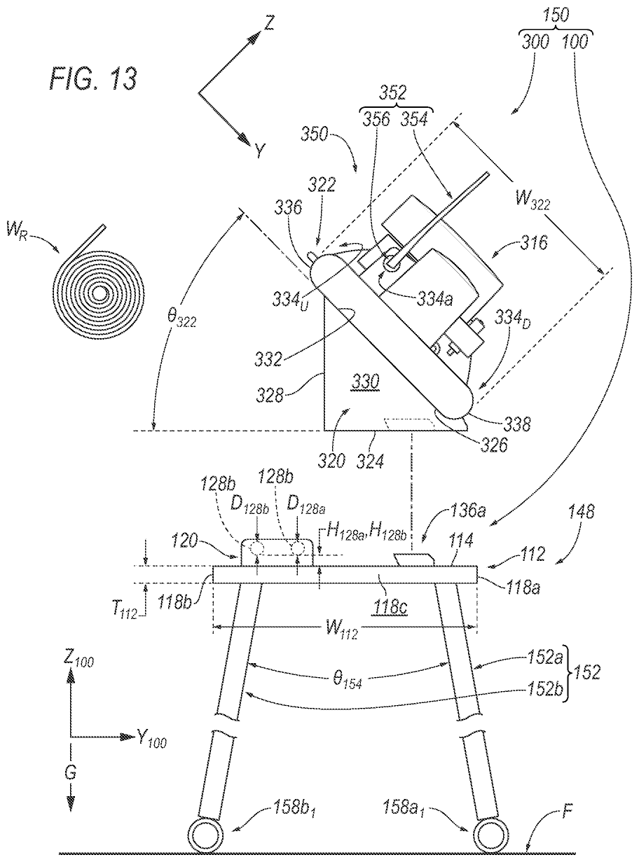

Furthermore, other embodiments of the present disclosure relate generally to a crafting apparatus assembly (see, e.g.: (1) an exemplary crafting apparatus assembly 50a at FIGS. 4, 6A, and 7-9; (2) another exemplary crafting apparatus assembly 50b at FIG. 6B; or (3) yet another crafting apparatus assembly 150 at FIGS. 13-18). The crafting apparatus assembly 50a or the crafting apparatus assembly 50b may include at least the crafting apparatus support member 10 connected to the crafting apparatus 300. The crafting apparatus assembly 150 may include at least the crafting apparatus support member 100 connected to the crafting apparatus 300.

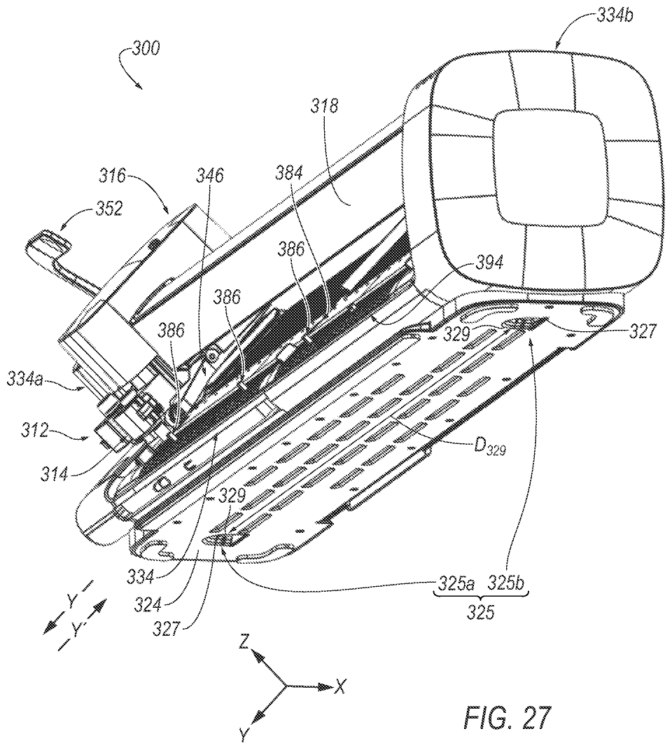

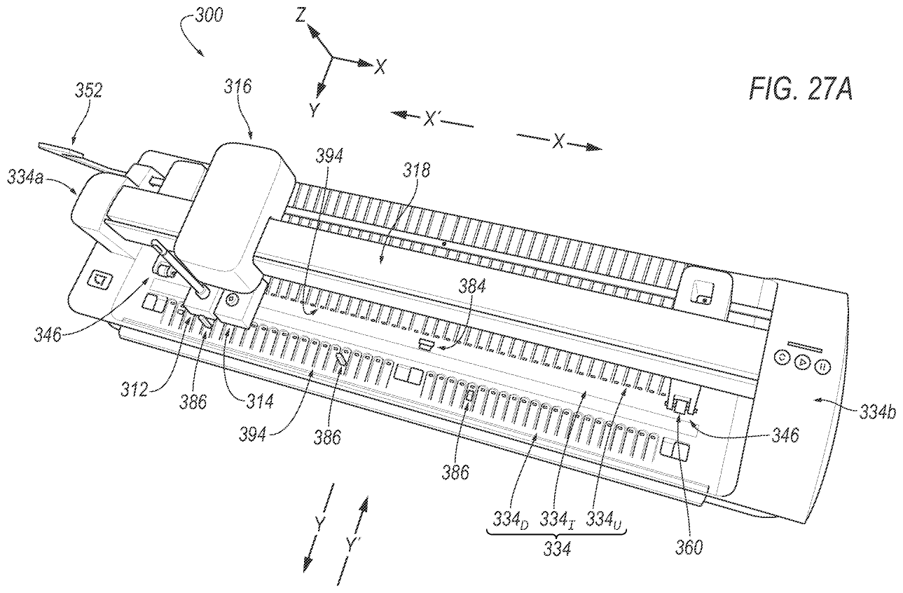

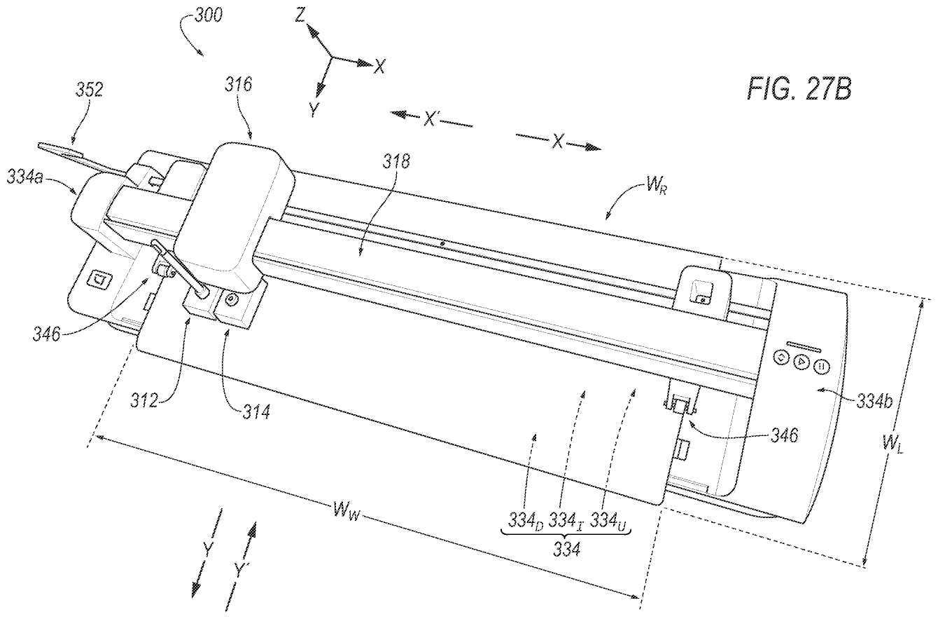

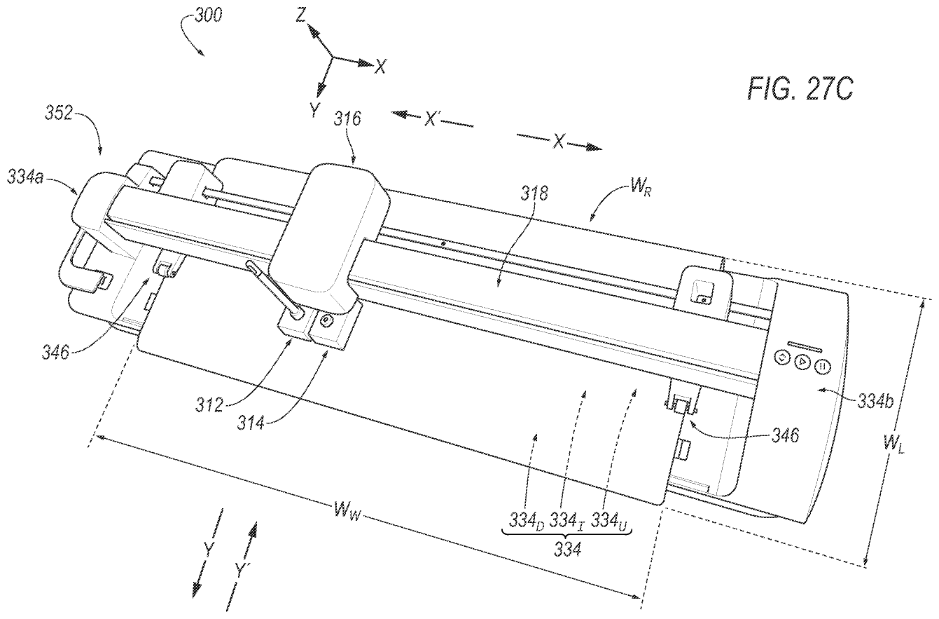

Any of the crafting apparatus assemblies 50a, 50b, 150 may further include a roll of workpiece material W_{R} that is rotatably-supported by the crafting apparatus support member 10, 100 in order to permit a workpiece W (that is reeled from the roll of workpiece material W_{R} as seen at FIGS. 27A-27C) to be connected to or interfaced with the crafting apparatus support member 10, 100. Once the reeled workpiece W is connected to or interfaced with the crafting apparatus support member 10, 100, the crafting apparatus support member 10, 100 may conduct “work” on the reeled workpiece W.

Referring to FIGS. 6A and 7-9, in some configurations, the crafting apparatus assembly 50a may further include a support portion, such as, for example, a table 75a. In some examples, the table 75a includes an upper surface 75_{U} that supports, with the assistance of gravity G, a lower surface 16 the crafting apparatus support member 10. Furthermore, the table 75a may include legs 75a_{L} that are arranged upon and disposed adjacent the underlying ground surface or floor F (see, e.g., FIGS. 6A and 7-9).

Referring to FIG. 6B, in other configurations, the crafting apparatus assembly 50b may further include the crafting apparatus support member 10 connected to a wall surface 75b_{W} (that may extend vertically from the underlying ground surface or floor F) of a wall 75b. The connection of the crafting apparatus support member 10 to the wall 75b may be provided by one or a combination of fasteners, brackets, hooks, adhesives, magnets, or the like. As seen at FIG. 6B, the crafting apparatus assembly 50b may be formed by, for example, connecting a rearward surface of the crafting apparatus support member 10 (see, e.g., a rear side surface 18b of a side surface 18 of a substantially planar body 12) to the wall surface 75b_{W} of the wall 75b. Accordingly, the crafting apparatus support member 10 may be connected to the wall 75b in a cantilevered or substantially cantilevered orientation whereby the lower surface 16 the crafting apparatus support member 10 is not supported by another object (e.g., a table 75a). In such an exemplary configuration as seen at FIG. 6B, by connecting the crafting apparatus support member 10 to the wall 75b, additional access to the upper surface 75_{U} of the table 75a is provided to a user (as compared to, for example, the exemplary embodiment seen at FIG. 6A whereby the table 75a supports the crafting apparatus support member 10 and the crafting apparatus 300).

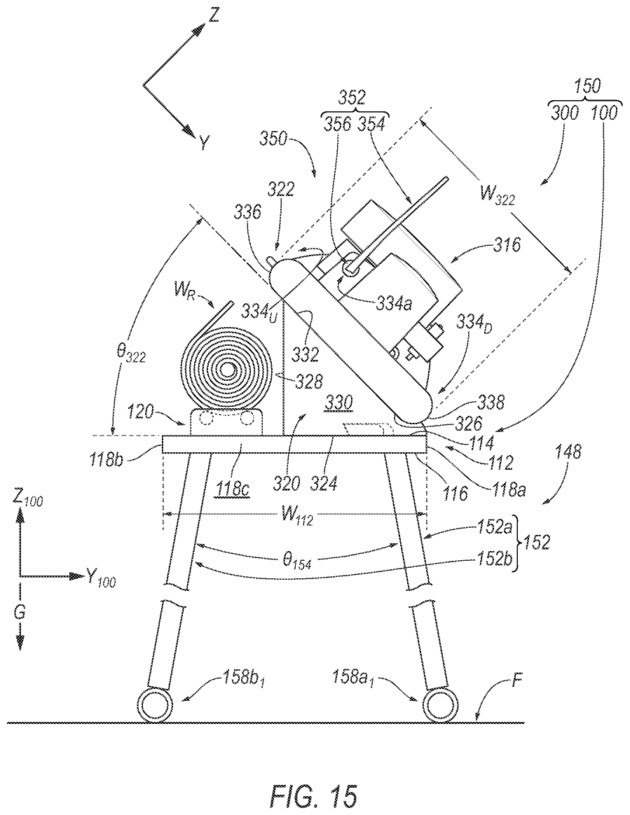

In yet other configurations, the crafting apparatus support member 100 of the crafting apparatus assembly 150 may further include a crafting apparatus support member management sub-assembly (see, e.g., a crafting apparatus support member management sub-assembly 148 at FIGS. 10, 13, 15-26). As seen at, for example, FIGS. 15-18, a lower surface 116 or a rear side surface 118b of a side surface 118 of a substantially planar body 112 of the crafting apparatus support member 100 is not configured to be supported by the support portion, such as, for example, a table, wall, or the like as described above with respect to the crafting apparatus assemblies 50a, 50b. Rather, the lower surface 116 of the substantially planar body 112 is supported by the crafting apparatus support member management sub-assembly 148, which will be described in greater detail in the following disclosure.

Referring to FIGS. 1-9, aspects of the crafting apparatus support member 10 are described. As seen at FIG. 1, the crafting apparatus support member 10 includes a substantially planar body 12. The substantially planar body 12 includes an upper surface 14, a lower surface 16, and a side surface 18. The side surface 18 connects the upper surface 14 to the lower surface 16. Furthermore, the side surface 18 defines a thickness T₁₂ of the substantially planar body 12 that extends between the upper surface 14 and the lower surface 16.

The side surface 18 of the substantially planar body 12 is further defined by a front side surface 18a and a rear side surface 18b arranged opposite the front side surface 18a. The side surface 18 is further defined by a first side surface 18c and a second side surface 18d arranged opposite the first side surface 18c.

Furthermore, the substantially planar body 12 is defined by a length L₁₂ extending between the first side surface 18c and a second side surface 18d. The substantially planar body 12 is further defined by a width W₁₂ extending between the front side surface 18a and a rear side surface 18b.

Yet even further, as seen at FIG. 1, the crafting apparatus support member 10 defines a “non-working” three dimensional X₁₀-Y₁₀-Z₁₀ Cartesian coordinate system. The “Z Direction” (i.e., Z₁₀) of the “non-working” three dimensional X₁₀-Y₁₀-Z₁₀ Cartesian coordinate system is orthogonal to the upper surface 14 of the substantially planar body 12 of the crafting apparatus support member 10. The “Y Direction” (i.e., Y₁₀) of the “non-working” three dimensional X₁₀-Y₁₀-Z₁₀ Cartesian coordinate system extends in the direction of the width W₁₂ of the substantially planar body 12 of the crafting apparatus support member 10. The “X Direction” (i.e., X₁₀) of the “non-working” three dimensional X₁₀-Y₁₀-Z₁₀ Cartesian coordinate system extends in the direction of the length L₁₂ of the substantially planar body 12 of the crafting apparatus support member 10.

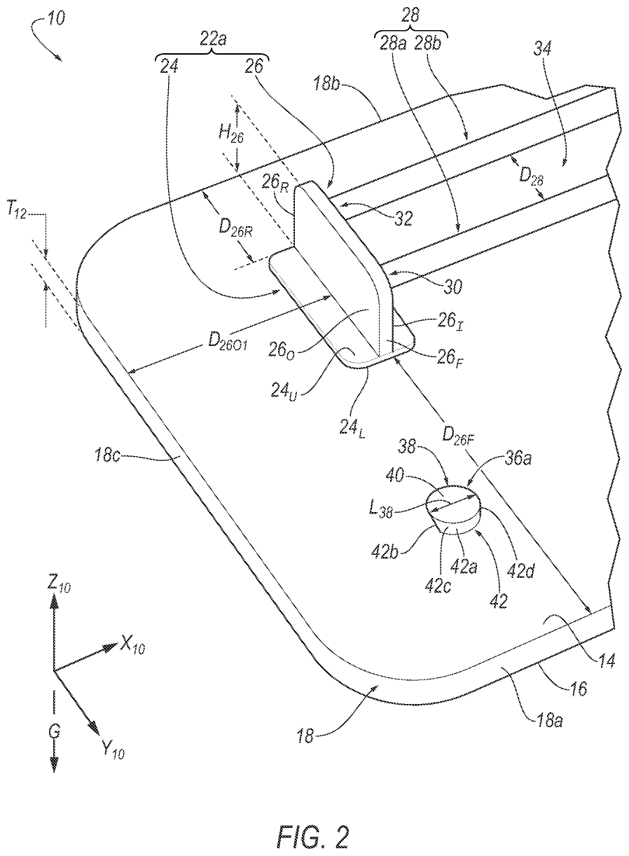

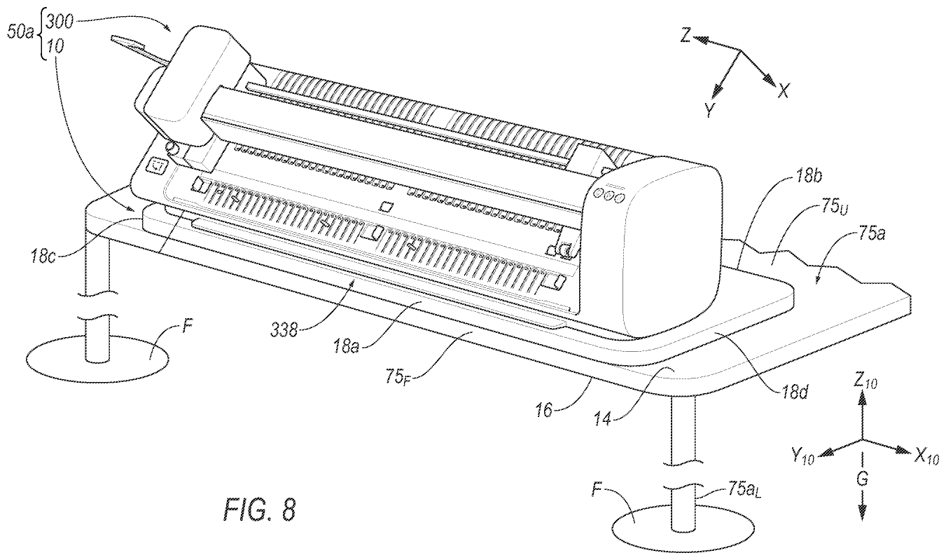

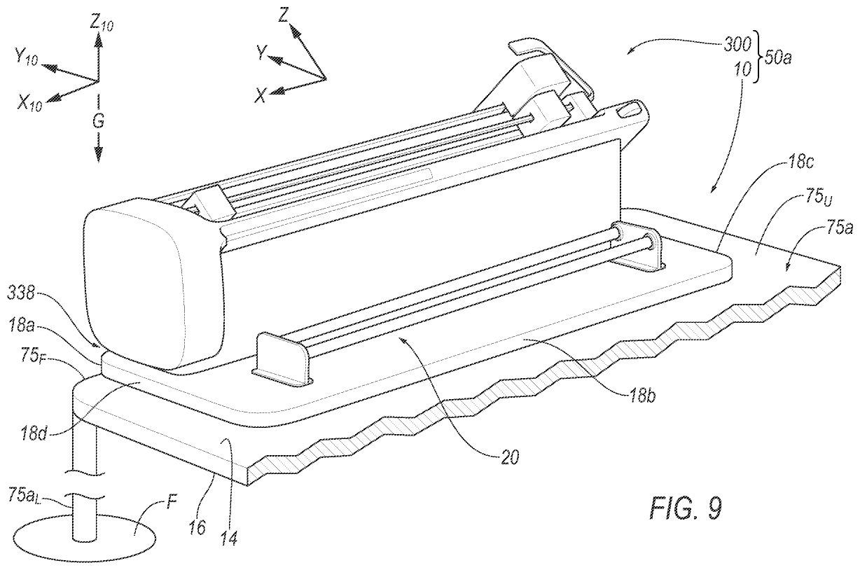

Furthermore, as seen at FIG. 1, the “Z Direction (i.e., the Z₁₀-axis)” of the “non-working” three dimensional X₁₀-Y₁₀-Z₁₀ Cartesian coordinate system is aligned and parallel with a gravitational axis defined by arrow G (see also, e.g., FIGS. 2-9) that generally illustrates a gravitational pull with respect to the underlying ground surface or floor F (see, e.g., FIGS. 4 and 6-9). Accordingly, as seen at FIG. 8 and as will be explained in greater detail in the following disclosure, because a “Z Direction (i.e., a Z-axis)” of a “working” three dimensional X-Y-Z Cartesian coordinate system (see, e.g., FIGS. 8 and 9) is angularly offset from the “Z Direction” (i.e., the Z₁₀-axis) of the “non-working” three dimensional X₁₀-Y₁₀-Z₁₀ Cartesian coordinate system by an angle θ322 (see, e.g., FIGS. 4, 6A, and 7) defined by a working portion 322 of the crafting apparatus 300, the “Z Direction (i.e., the Z-axis)” of the “working” three dimensional X-Y-Z Cartesian coordinate system is not aligned with, and traverses, the gravitational axis defined by the arrow G. Stated differently, the gravitational axis defined by the arrow G and the Z-axis of the “working” three dimensional X-Y-Z Cartesian coordinate system are not parallel and thus transverse one another.

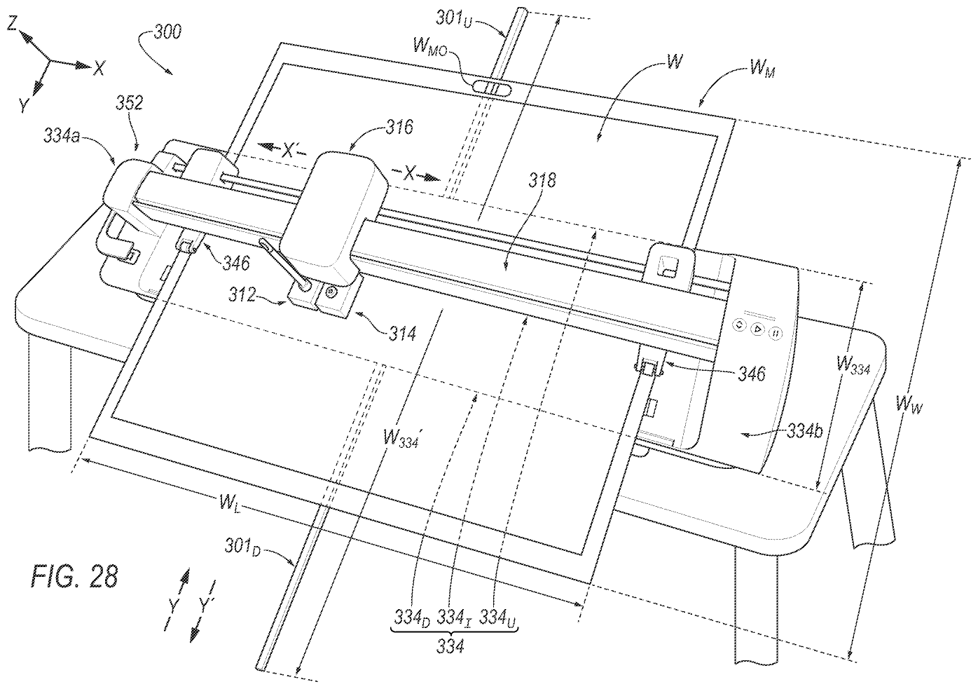

As will also be described in the following disclosure, the crafting apparatus 300 may be defined to be a “large form” crafting apparatus that is configured to conduct “work” on and manage “large form” workpieces W (see, e.g., FIGS. 27B, 27C, and 28) and/or a “large form” workpiece support mat W_{M} (see, e.g., FIG. 28). In some examples, with reference to, for example, FIG. 28, square or rectangular dimensions (e.g., a length W_{L} and a width W_{W}) of a “large form” workpiece W and/or a “large form” workpiece support mat W_{M} may be approximately equal to twenty-four inches (24″/61.0 centimeters) by twenty-four inches (24″/61.0 centimeters). In other examples, the square or rectangular dimensions W_{L}, W_{W} of the “large form” workpiece W and/or the “large form” workpiece support mat W_{M} may be approximately equal to twenty-four inches (24″/61.0 centimeters) by forty-eight inches (48″/122.0 centimeters). In yet other examples, the square or rectangular dimensions W_{L}, W_{W} of the relatively “large” square or rectangular workpiece W and/or the workpiece support mat W_{M} may be approximately equal to forty-eight inches (48″/122.0 centimeters) by forty-eight inches (48″/122.0 centimeters).

Although exemplary configurations of square or rectangular “large form” workpieces W and/or a square or rectangular “large form” workpiece support mats W_{M} are described above, the exemplary width dimensions W_{W} described above may also be applied to a workpiece W that is derived from the roll of workpiece material W_{R} (see, e.g., FIGS. 27B and 27C) that is rotatably-supported by the crafting apparatus support member 10, 100. Such an exemplary workpiece W may not be defined by a definitive length W_{L} (as seen at, e.g., FIG. 28) as a result of the length W_{L} of workpiece W being arranged in “rolled form” as a roll of workpiece material W_{R}.

Because the crafting apparatus 300 may be defined to be a “large form” crafting apparatus that is configured to conduct “work” on and manage “large form” workpieces W and/or a “large form” workpiece support mat W_{M} as described above, the crafting apparatus support member 10 may be correspondingly defined to be a “large form” crafting apparatus support member. In some embodiments as seen at, for example, FIG. 1, the length L₁₂ of the substantially planar body 12 (that extends in the “X Direction” (i.e., X₁₀) of the “non-working” three dimensional X₁₀-Y₁₀-Z₁₀ Cartesian coordinate system) may be greater than the width W₁₂ of the substantially planar body 12 (that extends in the “Y Direction” (i.e., Y₁₀) of the “non-working” three dimensional X₁₀-Y₁₀-Z₁₀ Cartesian coordinate system); as a result, the “large form” crafting apparatus support member 10 may be defined to have a substantially rectangular shape. Such an exemplary configuration of the length L₁₂ dimension of the substantially planar body 12 and the width W₁₂ dimension of the of the substantially planar body 12 may be approximately the same or slightly greater than corresponding length and width dimensions of the “large form” crafting apparatus 300, which may include a substantially rectangular footprint defined by a lower surface 324 (see, e.g., FIG. 27) of the “large form” crafting apparatus 300; accordingly, the “large form” crafting apparatus support member 10 is configured to provide a sufficient surface area of the upper surface 14 (see, e.g., a crafting apparatus support region S 300 that is generally bound by a dotted line) of the substantially planar body 12 in order to provide support the “large form” crafting apparatus 300.

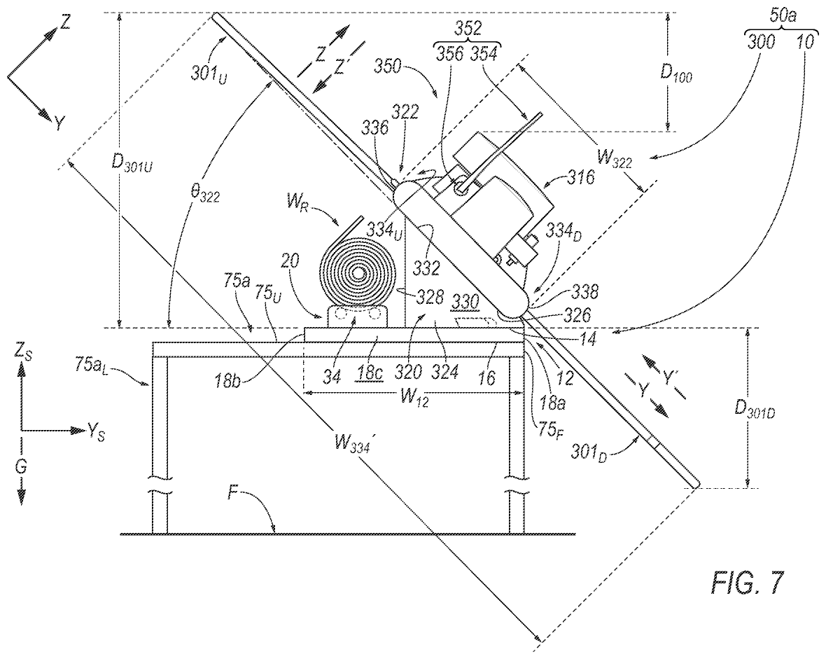

With continued reference to FIG. 1, the crafting apparatus support member 10 also includes a workpiece retainer assembly 20 that is connected to the upper surface 14 of the substantially planar body 12. As seen at FIGS. 6A, 6B, and 7, the workpiece retainer assembly 20 that is configured to rotatably-support the roll of workpiece material W_{R}.

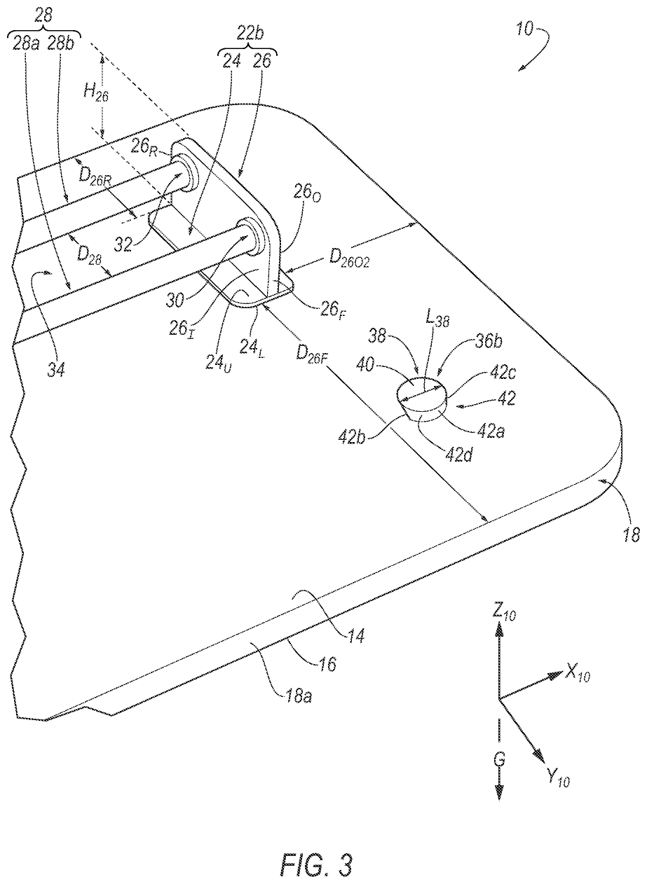

Referring to FIG. 1, the workpiece retainer assembly 20 includes a pair of bracket members 22 defined by a first bracket member 22a (see, e.g., FIG. 2) and a second bracket member 22b (see, e.g., FIG. 3). As seen at FIG. 1, with reference to the “Y Direction” (i.e., Y₁₀) of the “non-working” three dimensional X₁₀-Y₁₀-Z₁₀ Cartesian coordinate system, the pair of bracket members 22 are arranged closer to the rear side surface 18b of the side surface 18 of the substantially planar body 12 (at, for example, a first distance D_{26R} as seen at FIGS. 2 and 3) than the front side surface 18a of the side surface 18 of the substantially planar body 12 (at, for example, a second distance D_{26F} as seen at FIGS. 2 and 3).

Because the first distance D_{26R} may be less than the second distance D_{26F}, the workpiece retainer assembly 20 may, in some configurations, not be centered upon the upper surface 14 of the substantially planar body 12 according to the “Y Direction” (i.e., Y₁₀) of the “non-working” three dimensional X₁₀-Y₁₀-Z₁₀ Cartesian coordinate system. The second distance D_{26F} may be configured to be greater than the first distance D_{26R} in order to, for example, provide the sufficient surface area of the upper surface 14 of the substantially planar body 12 for the crafting apparatus support region S₃₀₀ in order to permit the crafting apparatus support member 10 to support the crafting apparatus 300. The crafting apparatus support region S₃₀₀ may be defined by between approximately about 65% to 75% of the surface area of the upper surface 14 of the substantially planar body 12 as defined by the length 1_42 dimension of the substantially planar body 12 and the width W₁₂ dimension of the of the substantially planar body 12.

Referring to FIGS. 2 and 3, each of the first bracket member 22a (see, e.g., FIG. 2) and the second bracket member 22b (see, e.g., FIG. 3) includes a base portion 24 and a flange portion 26. The flange portion 26 of each of the first bracket member 22a and the second bracket member 22b longitudinally extend in the “Y Direction” (i.e., Y₁₀) of the “non-working” three dimensional X₁₀-Y₁₀-Z₁₀ Cartesian coordinate system. Furthermore, the flange portion 26 extends away from the upper surface 24_{U} of each base portion 24 of each of the first bracket member 22a and the second bracket member 22b in the “Z Direction” (i.e., Z₁₀) of the “non-working” three dimensional X₁₀-Y₁₀-Z₁₀ Cartesian coordinate system at a height H₂₆.

With continued reference to FIGS. 2 and 3, the base portion 24 of each of the first bracket member 22a and the second bracket member 22b includes an upper surface 24_{U} and a lower surface 24_{L}. The lower surface 24_{L} of the base portion 24 of each of the first bracket member 22a and the second bracket member 22b is attached to the upper surface 14 of the substantially planar body 12.

The flange portion 26 of each of the first bracket member 22a and the second bracket member 22b includes an outwardly-facing surface, which is seen generally at 26o. The flange portion 26 of each of the first bracket member 22a and the second bracket member 22b also includes an inwardly-facing surface, which is seen generally at 261.

As seen at FIG. 2, the outwardly-facing surface 26o of the flange portion 26 of the first bracket member 22a is arrange at a first distance D_{26O1} from the first side surface 18c of the side surface 18 of the substantially planar body 12 according to the “X Direction” (i.e., X₁₀) of the “non-working” three dimensional X₁₀-Y₁₀-Z₁₀ Cartesian coordinate system. As seen at FIG. 3, the outwardly-facing surface 26_{O} of the flange portion 26 of the second bracket member 22b is arrange at a second distance D_{26O2} from the second side surface 18d of the side surface 18 of the substantially planar body 12 according to the “X Direction” (i.e., X₁₀) of the “non-working” three dimensional X₁₀-Y₁₀-Z₁₀ Cartesian coordinate system. In some configurations, the first distance D_{26O1} may be approximately equal to the second distance D_{26O2} such that the workpiece retainer assembly 20 is substantially centered upon the upper surface 14 of the substantially planar body 12 according to the “X Direction” (i.e., X₁₀) of the “non-working” three dimensional X₁₀-Y₁₀-Z₁₀ Cartesian coordinate system.

The inwardly-facing surface 26_{I} of the first bracket member 22a is arranged opposite and directly opposes or faces the inwardly-facing surface 26_{I} of the second bracket member 22b. Furthermore, as seen at FIG. 1, the inwardly-facing surface 26_{I} of the first bracket member 22a is spaced apart from the inwardly-facing surface 26_{I} of the second bracket member 22b at a distance D₂₆.

Referring to FIGS. 2 and 3, the flange portion 26 of each of the first bracket member 22a and the second bracket member 22b also includes a front-facing surface 26_{F} and a rear-facing surface 26R. The front-facing surface 26_{F} is arranged at the distance D_{26F} away from the front side surface 18a of the side surface 18 of the substantially planar body 12 according to the “Y Direction” (i.e., Y₁₀) of the “non-working” three dimensional X₁₀-Y₁₀-Z₁₀ Cartesian coordinate system. The rear-facing surface 26R is arranged at the distance D_{26R} away from the rear side surface 18b of the side surface 18 of the substantially planar body 12 according to the “Y Direction” (i.e., Y₁₀) of the “non-working” three dimensional X₁₀-Y₁₀-Z₁₀ Cartesian coordinate system.

As seen at FIG. 1, the workpiece retainer assembly 20 also includes a pair of rod members 28 defined by a first rod member 28a and a second rod member 28b. Each of the first rod member 28a and the second rod member 28b may have a substantially circular cross-sectional shape defined by a diameter (see, e.g., diameter D₂₈ₐ and diameter D_{28b} at FIG. 4).

Referring to FIGS. 2 and 3, each of the first rod member 28a and the second rod member 28b includes a first rod member end 30 and a second rod member end 32. Furthermore, as seen at FIG. 1, each of first rod member 28a and the second rod member 28b is defined by a length L₂₈ extending between the first rod member end 30 and the second rod member end 32. Furthermore, the length L₂₈ extending between the first rod member end 30 and the second rod member end 32 may define the distance D₂₆ at which the inwardly-facing surface 26_{I} of the first bracket member 22a is spaced apart from the inwardly-facing surface 26_{I} of the second bracket member 22b.

With reference to FIG. 2, the first rod member end 30 of the first rod member 28a is: (1) attached to the inwardly-facing surface 26_{I} of the flange portion 26 of the first bracket member 22a by a bearing (not shown); and (2) arranged near the front-facing surface 26r of the first bracket member 22a. Similarly, as seen at FIG. 3, the second rod member end 32 of the first rod member 28a is: (1) attached to the inwardly-facing surface 26_{I} of the flange portion 26 of the second bracket member 22b by a bearing (not shown); and (2) arranged near the front-facing surface 26_{F} of the second bracket member 22b.

Upon attaching the first rod member 28a to the first bracket member 22a and the second bracket member 22b as described above, the first rod member 28a extends in the “X Direction” (i.e., X₁₀) of the “non-working” three dimensional X₁₀-Y₁₀-Z₁₀ Cartesian coordinate system. Furthermore, as seen at FIG. 4, upon attaching the first rod member 28a to the first bracket member 22a and the second bracket member 22b as described above, a lower-most surface portion of the first rod member 28a is spaced apart from and extends away from the upper surface 14 of the substantially planar body 12 in the “Z Direction” (i.e., Z₁₀) of the “non-working” three dimensional X₁₀-Y₁₀-Z₁₀ Cartesian coordinate system at a height H₂₈ₐ.

With reference to FIG. 2, the first rod member end 30 of the second rod member 28b is: (1) attached to the inwardly-facing surface 26_{I} of the flange portion 26 of the first bracket member 22a by a bearing (not shown); and (2) arranged near the rear-facing surface 26_{R} of the first bracket member 22a. Similarly, as seen at FIG. 3, the second rod member end 32 of the second rod member 28b is: (1) attached to the inwardly-facing surface 26_{I} of the flange portion 26 of the second bracket member 22b by a bearing (not shown); and (2) arranged near the rear-facing surface 26R of the second bracket member 22b.

Upon attaching the second rod member 28b to the first bracket member 22a and the second bracket member 22b as described above, the second rod member 28b extends in the “X Direction” (i.e., X₁₀) of the “non-working” three dimensional X₁₀-Y₁₀-Z₁₀ Cartesian coordinate system. Furthermore, as seen at FIG. 4, upon attaching the second rod member 28b to the first bracket member 22a and the second bracket member 22b as described above, a lower-most surface portion of the second rod member 28b is spaced apart from and extends away from the upper surface 14 of the substantially planar body 12 in the “Z Direction” (i.e., Z₁₀) of the “non-working” three dimensional X₁₀-Y₁₀-Z₁₀ Cartesian coordinate system at a height H_{28b}.

Referring to FIGS. 2 and 3, after both of the first rod member 28a and the second rod member 28b are attached to the first bracket member 22a and the second bracket member 22b as described above, opposing surfaces of the first rod member 28a and the second rod member 28b are spaced apart from one another in the “Y Direction” (i.e., Y₁₀) of the “non-working” three dimensional X₁₀-Y₁₀-Z₁₀ Cartesian coordinate system at a distance D₂₈. Furthermore, the spacing between the first rod member 28a and the second rod member 28b at the distance D₂₈ defines a roll of workpiece-material-receiving gap 34 that is configured, as seen at FIGS. 6A, 6B, and 7, to permit passage of only a portion of the roll of workpiece material W_{R} there-through while the first rod member 28a and the second rod member 28b axially support the roll of workpiece material W_{R} in the “Z Direction” (i.e., Z₁₀) of the “non-working” three dimensional X₁₀-Y₁₀-Z₁₀ Cartesian coordinate system.

As seen at FIG. 1, the crafting apparatus support member 10 includes one or more crafting apparatus interface portions 36. In some configurations, the one or more crafting apparatus interface portions 36 includes a pair of crafting apparatus interface portions. The pair of crafting apparatus interface portions 36 includes a first crafting apparatus interface portion 36a (as also seen at, e.g., FIG. 2) and a second crafting apparatus interface portion 36b (as also seen at, e.g., FIG. 3).

With reference to FIGS. 2 and 3, each crafting apparatus interface portion 36a, 36b of the pair of crafting apparatus interface portions 36 includes a boss 38. In some configurations, the boss 38 of each crafting apparatus interface portion 36a, 36b may be integrally formed with the substantially planar body 12 (see, e.g., the cross-sectional hatching at FIG. 5A). In other configurations, the boss 38 of each crafting apparatus interface portion 36a, 36b may be formed separately from and attached to the substantially planar body 12.

As seen at FIGS. 2 and 3, the boss 38 of each crafting apparatus interface portion 36a, 36b includes an upper surface 40 and a side surface 42 connecting the upper surface 40 of the boss 38 of each crafting apparatus interface portion 36a, 36b to the upper surface 14 of the substantially planar body 12. The side surface 42 defines a thickness T₃₈ (see, e.g., FIG. 5A) of the boss 38 that extends between the upper surface of each crafting apparatus interface portion 36a, 36b and the upper surface 14 of the substantially planar body 12 according to the “Z Direction” (i.e., Z₁₀) of the “non-working” three dimensional X₁₀-Y₁₀-Z₁₀ Cartesian coordinate system.

With continued reference to FIGS. 2 and 3, the side surface 42 of each crafting apparatus interface portion 36a, 36b is further defined by a front side surface 42a (see also, e.g., FIG. 5A) and a rear side surface 42b (see also, e.g., FIG. 5A) arranged opposite the front side surface 42a. The side surface 42 of each crafting apparatus interface portion 36a, 36b is further defined by an outwardly-facing side surface 42c and an inwardly-facing side surface 42d arranged opposite the outwardly-facing side surface 42c.

Furthermore, the boss 38 is defined by a length L₃₈ extending between the outwardly-facing side surface 42c and the inwardly-facing side surface 42d according to the “X Direction” (i.e., X₁₀) of the “non-working” three dimensional X₁₀-Y₁₀-Z₁₀ Cartesian coordinate system. The boss 38 is further defined by a width W₃₈ (see, e.g., FIG. 5A) extending between the front side surface 42a and a rear side surface 42b according to the “Y Direction” (i.e., Y₁₀) of the “non-working” three dimensional X₁₀-Y₁₀-Z₁₀ Cartesian coordinate system.

In some configurations, the boss 38 of each crafting apparatus interface portion 36a, 36b may have a substantially cylindrical shape, but with one of the side surfaces thereof having an angled, slanted, or curved wall, as described in greater detail below. In some configurations, each boss 38 may be angled in a certain direction (e.g., rearward), and thus a cylindrically shaped boss may extend from the upper surface 14 of the planar body 12 at an angle (e.g., at the angle θ₄₆ described below).

In some configurations, as seen at FIGS. 2 and 3, the front side surface 42a of the side surface 42 of the boss 38 of each crafting apparatus interface portion 36a, 36b may include a curved or arcuate shape, and the front side surface 42a may extend between and connects the upper surface 14 of the substantially planar body 12 and the upper surface 40 of the boss 38. In other configurations, both of the outwardly-facing side surface 42c and the inwardly-facing side surface 42d of the boss 38 of each crafting apparatus interface portion 36a, 36b may include a substantially flat or planar surface, and each of the outwardly-facing side surface 42c and the inwardly-facing side surface 42d may extend substantially perpendicularly between and connects the upper surface 14 of the substantially planar body 12 and the upper surface 40 of the boss 38.

In some examples, the rear side surface 42b of the side surface 42 of the boss 38 of each crafting apparatus interface portion 36a, 36b includes a substantially flat or planar surface, and the rear side surface 42b may extend between and connect the upper surface 14 of the substantially planar body 12 and the upper surface 40 of the boss 38. Unlike the outwardly-facing side surface 42c and the inwardly-facing side surface 42d, however, as seen at FIGS. 2, 3, and 5A, the rear side surface 42b of the side surface 42 of the boss 38 of each crafting apparatus interface portion 36a, 36b does not extend perpendicularly between the upper surface 14 of the substantially planar body 12 and the upper surface 40 of the boss 38; rather, the rear side surface 42b of the side surface 42 of the boss 38 of each crafting apparatus interface portion 36a, 36b extends non-perpendicularly from the upper surface 14 of the substantially planar body 12 at an angle θ_{42b} (see, e.g., FIG. 5A). As seen at FIG. 5A, the angle θ_{42b} is defined by and extends between the upper surface 14 of the substantially planar body 12 and the rear side surface 42b of the side surface 42 of the boss 38 of each crafting apparatus interface portion 36a, 36b. In some configurations the angle θ_{42b} may be an obtuse angle that may be equal to approximately 135°.

Furthermore, the rear side surface 42b of the side surface 42 of the boss 38 of each crafting apparatus interface portion 36a, 36b extends from the upper surface 40 of the boss 38 to define a nose portion 44 of the boss 38 of each crafting apparatus interface portion 36a, 36b. The rear side surface 42b of the side surface 42 of the boss 38 of each crafting apparatus interface portion 36a, 36b and the upper surface 14 of the substantially planar body 12 may also define, as seen at FIG. 5A, a recessed region 46 defined by an angle θ₄₆ that extends between the upper surface 14 of the substantially planar body 12 and the rear side surface 42b of the side surface 42 of the boss 38 of each crafting apparatus interface portion 36a, 36b. In some configurations the angle θ₄₆ defining the recessed region 46 may be between approximately 45° and 80°. In some configurations the angle θ₄₆ defining the recessed region 46 may be between approximately 60° and 75°. In some configurations the angle θ₄₆ defining the recessed region 46 may be an acute angle that may be equal to approximately 45°. As used in this context, the term approximately refers to plus or minus 5°.

As seen at FIG. 1, with reference to the “Y Direction” (i.e., Y₁₀) of the “non-working” three dimensional X₁₀-Y₁₀-Z₁₀ Cartesian coordinate system, the pair of crafting apparatus interface portions 36 are arranged closer to the front side surface 18a of the side surface 18 of the substantially planar body 12 (at, for example, a first distance D₄₂ₐ) than the rear side surface 18b of the side surface 18 of the substantially planar body 12 (at, for example, a second distance D_{42b}).

Because the first distance D₄₂ₐ may be less than the second distance D_{42b}, the pair of crafting apparatus interface portions 36 may, in some configurations, not be centered upon the upper surface 14 of the substantially planar body 12 according to the “Y Direction” (i.e., Y₁₀) of the “non-working” three dimensional X₁₀-Y₁₀-Z₁₀ Cartesian coordinate system. The second distance D_{42b} may be configured to be greater than the first distance D₄₂ₐ in order to provide the crafting apparatus support region S₃₀₀ of the crafting apparatus support member 10.

As seen at FIG. 1, the inwardly-facing surface 42d of the first crafting apparatus interface portion 36a is arranged opposite and directly opposes or faces the inwardly-facing surface 42d of the second crafting apparatus interface portion 36b. Furthermore, the inwardly-facing surface 42d of the first crafting apparatus interface portion 36a is spaced apart from the inwardly-facing surface 42d of the second crafting apparatus interface portion 36b at a distance (see, e.g., distance D₃₆).

The front side surface 42a of the side surface 42 of the boss 38 of each crafting apparatus interface portion 36a, 36b is arranged at the distance D₄₂ₐ away from the front side surface 18a of the side surface 18 of the substantially planar body 12 according to the “Y Direction” (i.e., Y₁₀) of the “non-working” three dimensional X₁₀-Y₁₀-Z₁₀ Cartesian coordinate system. The rear side surface 42b of the side surface 42 of the boss 38 of each crafting apparatus interface portion 36a, 36b is arranged at the distance D_{42b} away from the rear side surface 18b of the side surface 18 of the substantially planar body 12 according to the “Y Direction” (i.e., Y₁₀) of the “non-working” three dimensional X₁₀-Y₁₀-Z₁₀ Cartesian coordinate system.

Referring to FIGS. 5A and 27, the crafting apparatus 300 includes a lower surface 324 that includes one or more boss-receiving cavities 325. In some configurations, the one or more boss-receiving cavities 325 includes a pair of boss-receiving cavities 325. The pair of boss-receiving cavities 325 includes a first boss-receiving cavity 325a (that corresponds to the boss 38 of first crafting apparatus interface portion 36a) and a second boss-receiving cavity 325b (that corresponds to the boss 38 of second crafting apparatus interface portion 36b). Each boss-receiving cavity 325a, 325b of the pair of boss-receiving cavities 325 is configured to include an opening 327 that is sized to respectively receive, as seen at FIG. 5A, the boss 38 of each crafting apparatus interface portion 36a, 36b and then subsequently selectively removably-connect, as seen at FIGS. 5B-5C, the boss 38 of each crafting apparatus interface portion 36a, 36b within, respectively, each boss-receiving cavity 325a, 325b of the pair of boss-receiving cavities 325.

With reference to FIG. 5A, each of the first boss-receiving cavity 325a and the second boss-receiving cavity 325b defines a depth that extends into the lower surface 324 of the crafting apparatus 300 at a distance D₃₂₅ extending in the “Z Direction” (i.e., Z₁₀) of the “non-working” three dimensional X₁₀-Y₁₀-Z₁₀ Cartesian coordinate system toward a recessed lower surface portion 324_{R} of the lower surface 324 of the crafting apparatus 300. The distance D₃₂₅ of each of the first boss-receiving cavity 325a and the second boss-receiving cavity 325b is approximately equal to the thickness T₃₈ of the boss 38 of each crafting apparatus interface portion 36a, 36b.

Furthermore, as seen at FIG. 5A, each of the first boss-receiving cavity 325a and the second boss-receiving cavity 325b defines a width W₃₂₅ (extending in the “Y Direction” (i.e., Y₁₀) of the “non-working” three dimensional X₁₀-Y₁₀-Z₁₀ Cartesian coordinate system) that extends between a front side surface 329a and a rear side surface 329b of each of the first boss-receiving cavity 325a and the second boss-receiving cavity 325b. The width W₃₂₅ of each of the first boss-receiving cavity 325a and the second boss-receiving cavity 325b may be non-constant. For example, the width W₃₂₅ of each of the first boss-receiving cavity 325a and the second boss-receiving cavity 325b may increase, at least initially, as each of the first boss-receiving cavity 325a and the second boss-receiving cavity 325b extends in the “Z Direction” (i.e., Z₁₀) of the “non-working” three dimensional X₁₀-Y₁₀-Z₁₀ Cartesian coordinate system from the recessed lower surface portion 3248 toward the lower surface 324 of the crafting apparatus 300.

A minimum amount of the width W₃₂₅ of each of the first boss-receiving cavity 325a and the second boss-receiving cavity 325b is greater than (e.g., approximately equal to but perhaps slightly greater than) a width W₃₆ extending between the front side surface 42a and the rear side surface 42b of the boss 38 of each crafting apparatus interface portion 36a, 36b. A maximum amount of the width W₃₂₅ of each of the first boss-receiving cavity 325a and the second boss-receiving cavity 325b is greater than the width W₃₆ extending between the front side surface 42a and the rear side surface 42b of the boss 38 of each crafting apparatus interface portion 36a, 36b.

Each of the first boss-receiving cavity 325a and the second boss-receiving cavity 325b is defined by a side surface 329 that is further defined by a front side surface 329a (see, e.g., FIG. 5A) and a rear side surface 329b (see, e.g., FIG. 5A) arranged opposite the front side surface 329a. The side surface 329 of each the first boss-receiving cavity 325a and the second boss-receiving cavity 325b is further defined by an outwardly-facing side surface (not shown) and an inwardly-facing side surface (not shown) arranged opposite the outwardly-facing side surface. Furthermore, each of the first boss-receiving cavity 325a and the second boss-receiving cavity 325b is defined by a length extending between the outwardly-facing side surface and the inwardly-facing side surface according to the “X Direction” (i.e., X₁₀) of the “non-working” three dimensional X₁₀-Y₁₀-Z₁₀ Cartesian coordinate system.

In some configurations, each of the boss-receiving cavities 325a, 352b may have a substantially cylindrical shape, but with one of the side surfaces thereof having an angled, slanted, or curved wall, as described in greater detail below. In some configurations, each boss-receiving cavity 325a, 352b may be angled in a certain direction (e.g., rearward) and may thus be configured to receive a similarly shaped/angled cylindrical boss 38.

In some configurations, the front side surface 329a of the side surface 329 of each of the first boss-receiving cavity 325a and the second boss-receiving cavity 325b may include a curved or arcuate shape that corresponds to the curved or arcuate shape of the front side surface 42a of the side surface 42 of the boss 38 of each crafting apparatus interface portion 36a, 36b. In other configurations, both of the outwardly-facing side surface and the inwardly-facing side surface of each of the first boss-receiving cavity 325a and the second boss-receiving cavity 325b may include a substantially flat or planar surface that extends substantially perpendicularly from the lower surface 324 of the crafting apparatus 300 toward the recessed lower surface portion 324_{R} of the lower surface 324 at the distance D₃₂₅; furthermore, both of the outwardly-facing side surface and the inwardly-facing side surface of each of the first boss-receiving cavity 325a are configured to respectively correspond to the outwardly-facing side surface 42c and the inwardly-facing side surface 42d of the boss 38 of each crafting apparatus interface portion 36a, 36b.

Furthermore, in some examples, the rear side surface 329b of the side surface 329 each of the first boss-receiving cavity 325a and the second boss-receiving cavity 325b includes a substantially flat or planar surface, and the rear side surface 329b of the side surface 329 each of the first boss-receiving cavity 325a and the second boss-receiving cavity 325b may extend between and connects the lower surface 324 of the crafting apparatus 300 and the recessed lower surface portion 324_{R} of the lower surface 324. Unlike the outwardly-facing side surface 329c and the inwardly-facing side surface 329d, however, as seen at FIG. 5A, the rear side surface 329b of the side surface 329 of each of the first boss-receiving cavity 325a and the second boss-receiving cavity 325b may not extend perpendicularly between the lower surface 324 of the crafting apparatus 300 and the recessed lower surface portion 324_{R} of the lower surface 324; rather, the rear side surface 329b of the side surface 329 of each of the first boss-receiving cavity 325a and the second boss-receiving cavity 325b may extend non-perpendicularly from the lower surface 324 of the crafting apparatus 300 at an angle θ_{329b} to thereby define a hooking portion 231. The hooking portion 231 that is defined by the lower surface 324 of the crafting apparatus 300 and the rear side surface 329b of the side surface 329 of each of the first boss-receiving cavity 325a and the second boss-receiving cavity 325b is configured to be mateably-received within the recessed region 46 formed by the rear side surface 42b of the side surface 42 of the boss 38 of each crafting apparatus interface portion 36a, 36b and the upper surface 14 of the substantially planar body 12. In some configurations the angle θ_{329b} may be between approximately 45° and 80°. In some configurations the angle θ_{329b} may be between approximately 60° and 75°. In some configurations, the angle θ_{329b} that defines the hooking portion 231 may be equal to approximately 45°. As used in this context, the term approximately refers to plus or minus 5°.

Furthermore, as seen at FIG. 5A, the connection of the recessed lower surface portion 324_{R} of the lower surface 324 and the rear side surface 329b of the side surface 329 of each of the first boss-receiving cavity 325a and the second boss-receiving cavity 325b is defined by a cavity angle θ₃₂₅. In some configurations the angle θ₃₂₅ may be between approximately 45° and 80°. In some configurations the angle θ₃₂₅ may be between approximately 60° and 75°. In some configurations, the cavity angle θ₃₂₅ may be approximately equal to 45°. The cavity angle θ₃₂₅ is sized to receive the nose portion 44 of the boss 38 of each crafting apparatus interface portion 36a, 36b. As will be described in the following disclosure: (1) upon axially receiving (see, e.g., FIGS. 5A-5B) each crafting apparatus interface portion 36a, 36b within each of the first boss-receiving cavity 325a and the second boss-receiving cavity 325b according to the direction of the arrow Z′ in the “Z Direction” (i.e., Z₁₀) of the “non-working” three dimensional X₁₀-Y₁₀-Z₁₀ Cartesian coordinate system; and then (2) subsequently sliding (see, e.g., FIGS. 5B-5C) the crafting apparatus 300 according to the direction of the arrow Y in the “Y Direction” (i.e., Y₁₀) of the “non-working” three dimensional X₁₀-Y₁₀-Z₁₀ Cartesian coordinate system relative the crafting apparatus support member 10, the nose portion 44 of each crafting apparatus interface portion 36a, 36b is matably-received within each of the first boss-receiving cavity 325a and the second boss-receiving cavity 325b. Such as arrangement stops the sliding movement (as seen at FIG. 5C) of the crafting apparatus 300 in the direction of the arrow Y in the “Y Direction” (i.e., Y₁₀) of the “non-working” three dimensional X₁₀-Y₁₀-Z₁₀ Cartesian coordinate system relative the crafting apparatus support member 10 such that the front edge 18a the side surface 18 of the substantially planar body 12 is substantially axially aligned with a front surface 338 of the working portion 322 of the crafting apparatus 300 in the “Z Direction” (i.e., Z₁₀) of the “non-working” three dimensional X₁₀-Y₁₀-Z₁₀ Cartesian coordinate system. Furthermore, the because the nose portion 44 extends non-perpendicularly from the upper surface 14 of the substantially planar body 12 at the angle θ_{42b} and is matably-interfaced with the corresponding cavity angles θ₃₂₅ formed by the first boss-receiving cavity 325a and the second boss-receiving cavity 325b, the crafting apparatus 300 may be said to be “hooked” by the crafting apparatus interface portions 36a, 36b, and, therefore, any imparted external force to the crafting apparatus 300 (according to, e.g., one or a combination the arrow Y or a direction opposite the arrow Z′) that may otherwise result in rotational or pivoting movement of the crafting apparatus 300 off of or away from the upper surface 14 of the substantially planar body 12 is limited or mitigated. Therefore, the crafting apparatus support member 10 may prevent the crafting apparatus 10 from being dislodged from the upper surface 14 of the substantially planar body 12 or sliding off of the upper surface 14 of the substantially planar body 12 according to the direction of the arrow Y past the front edge 18a the side surface 18 of the substantially planar body 12.

As seen at FIG. 27, the inwardly-facing surface of the first boss-receiving cavity 325a is arranged opposite and directly opposes or faces the inwardly-facing surface of the second boss-receiving cavity 325b. Furthermore, the inwardly-facing surface of the first boss-receiving cavity 325a is spaced apart from the inwardly-facing surface of the second boss-receiving cavity 325b at a distance (see, e.g., distance D₃₂₉).

As seen at FIG. 5A, the front side surface 329a of the side surface 329 of each of the first boss-receiving cavity 325a and the second boss-receiving cavity 325b is arranged at a distance D₃₂₉ₐ away from a front side surface 226 of the crafting apparatus 300 according to the “Y Direction” (i.e., Y₁₀) of the “non-working” three dimensional X₁₀-Y₁₀-Z₁₀ Cartesian coordinate system. The rear side surface 329b of the side surface 329 of each of the first boss-receiving cavity 325a and the second boss-receiving cavity 325b is arranged at a distance D_{329b} away from a rear side surface 328 of the crafting apparatus 300 according to the “Y Direction” (i.e., Y₁₀) of the “non-working” three dimensional X₁₀-Y₁₀-Z₁₀ Cartesian coordinate system.

The distances D₃₂₉, D₃₂₉a, and D₃₂₉b associated with the arrangement of the first boss-receiving cavity 325a and the second boss-receiving cavity 325b formed in the lower surface 324 of the crafting apparatus 300 generally respectively correspond to the distances D₃₆, D₄₂ₐ, and D_{42b} associated with the boss 38 of each crafting apparatus interface portion 36a, 36b. Accordingly, as seen at FIG. 5A, when the crafting apparatus 300 is: (1) moved in a first direction according to the arrow Z′ in the “Z Direction” (i.e., Z₁₀) of the “non-working” three dimensional X₁₀-Y₁₀-Z₁₀ Cartesian coordinate system; and then, as seen at FIG. 5B when the crafting apparatus 300 is (2) moved in a second direction according to the arrow Y in the “Y Direction” (i.e., Y₁₀) of the “non-working” three dimensional X₁₀-Y₁₀-Z₁₀ Cartesian coordinate system, the boss 38 of each crafting apparatus interface portion 36a, 36b is respectively configured to be arranged within and subsequently selectively removably-connected to (as seen at FIG. 5C) each of, respectively, the first boss-receiving cavity 325a and the second boss-receiving cavity 325b formed in the lower surface 324 of the crafting apparatus 300.

As a result of the corresponding relationship of: (1) the distances D₃₆, D₄₂ₐ, D₄₂b associated with the boss 38 of each crafting apparatus interface portion 36a, 36b relative the side surface 18 of the substantially planar body 12 and the distances D₃₂₉, D₃₂₉ₐ, D_{329b} associated with the arrangement of the first boss-receiving cavity 325a and the second boss-receiving cavity 325b of the crafting apparatus 300; and (2) the distances D_{26F}, D_{26R}, D_{26O1}, D_{26O2} associated with the workpiece retainer assembly 20 relative the side surface 18 of the substantially planar body 12, the crafting apparatus support member 10 will automatically align or blindly align: (A) the crafting apparatus 300 with respect to the roll of workpiece material W_{R} in the “X Direction” (i.e., X₁₀) of the “non-working” three dimensional X₁₀-Y₁₀-Z₁₀ Cartesian coordinate system; and (B) a front edge 18a the side surface 18 of the substantially planar body 12 with a front surface 338 of a working portion 322 of the crafting apparatus 300 in the “Z Direction” (i.e., Z₁₀) of the “non-working” three dimensional X₁₀-Y₁₀-Z₁₀ Cartesian coordinate system. In other words, the boss 38 of each crafting apparatus interface portion 36a, 36b and the workpiece retainer assembly 20 are intentionally and deliberately located upon the upper surface 14 of the substantially planar body 12 in order to permit a user to quickly and easily automatically align or blindly align crafting apparatus 300 with respect to the roll of workpiece material W_{R} and the front edge 18a the side surface 18 of the substantially planar body 12. As a result, when the workpiece W is reeled from the roll of workpiece material W_{R}, any jamming of the workpiece W with respect to a reeling direction (in the “X Direction” (i.e., X₁₀) of the “non-working” three dimensional X₁₀-Y₁₀-Z₁₀ Cartesian coordinate system) may be mitigated. Furthermore, as will be described in the following disclosure, as a result of substantially aligning the front surface 338 of a working portion 322 of the crafting apparatus 300 with the front edge 18a the side surface 18 of the substantially planar body 12 in the “Z Direction” (i.e., Z₁₀) of the “non-working” three dimensional X₁₀-Y₁₀-Z₁₀ Cartesian coordinate system, a downstream workpiece support member (see, e.g., downstream support arm 301_{D} of the crafting apparatus 300 is permitted to deploy at a distance (see, e.g., D_{301D} at FIG. 7) at least below the upper surface 14 of the substantially planar body 12 of the crafting apparatus support member 10.

Referring to FIGS. 6A-9, when the crafting apparatus 300 is selectively removably-connected to the crafting apparatus support member 10 as described above and as seen at FIGS. 5A-5C, a crafting apparatus assembly is formed as seen generally at 50a (see, e.g., FIG. 6A), 50B (see, e.g., FIG. 6B). In some configurations, the crafting apparatus assembly 50a, 50b may further include the roll of workpiece material W_{R} arranged upon and supported by the workpiece retainer assembly 20. As seen at FIG. 6A, the crafting apparatus assembly 50a may further include the lower surface 16 of the substantially planar body 12 of the crafting apparatus support member 10 arranged upon an upper surface 75_{U} of the table 75a that is arranged upon an underlying ground surface or floor F. However, in other configurations as seen at FIG. 6B, the crafting apparatus assembly 50b, the lower surface 16 of the substantially planar body 12 of the crafting apparatus support member 10 is not arranged upon the upper surface 75_{U} of the table 75a, but, rather, a rearward surface of the crafting apparatus support member 10 (see, e.g., the rear side surface 18b of the side surface 18 of the substantially planar body 12) is connected to the wall surface 75b_{W} of the wall 75b.

Furthermore, with reference to both of FIGS. 6A and 6B, when the crafting apparatus 300 is selectively removably-connected to the crafting apparatus support member 10 as described above and as seen at FIGS. 5A-5C, a front surface 338 of a working portion 322 of the crafting apparatus 300 is substantially aligned with (in the “Z Direction” (i.e., Z₁₀) of the “non-working” three dimensional X₁₀-Y₁₀-Z₁₀ Cartesian coordinate system) the front side surface 18a of the side surface 18 of the substantially planar body 12 of the crafting apparatus support member 10. Even further, as seen at FIGS. 6A and 7, in some configurations, the front side surface 18a of the side surface 18 of the substantially planar body 12 of the crafting apparatus support member 10 is substantially aligned with (in the “Z Direction” (i.e., Z₁₀) of the “non-working” three dimensional X₁₀-Y₁₀-Z₁₀ Cartesian coordinate system) a front surface 75_{F} of the table 75a.

With continued reference to FIGS. 6A and 7, arrangement of the front surface 238 of a working portion 322 of the crafting apparatus 300 proximate or in substantial alignment with one or both of the front side surface 18a of the side surface 18 of the substantially planar body 12 and the front surface 75_{F} of the table 75a permits deployment (from a stowed orientation as seen at FIG. 6A to a deployed orientation as seen at FIG. 7) of a downstream workpiece support member (see, e.g., downstream support arm 301_{D} of the crafting apparatus 300 at a distance (see, e.g., D_{301D} at FIG. 7) below one or both of the upper surface 14 of the substantially planar body 12 of the crafting apparatus support member 10 and the upper surface 75_{U} of the table 75a. Furthermore, as seen at FIG. 7, the crafting apparatus 10 also permits deployment (from a stowed orientation as seen at FIG. 6A to a deployed orientation as seen at FIG. 7) of an upstream workpiece support member 301_{U} of the crafting apparatus 300 at a distance (see, e.g., D_{301U}) above the upper surface 14 of the substantially planar body 12 of the crafting apparatus support member 10.

Similarly, with reference to FIG. 6B when the crafting apparatus support member 10 is connected to the wall 75b, the user may wish to arrange one or more of the downstream support arm 3010 and the upstream workpiece support member 301_{U} in the deployed orientation. While the downstream support arm 301p could be deployed (at a distance D_{301D} at seen at FIG. 7) below the upper surface 14 of the substantially planar body 12 of the wall-mounted crafting apparatus support member 10 of FIG. 6B, the crafting apparatus 300 may be arranged at a distance D₃₀₀ from the wall surface 75b_{W} of the wall 75b that is not sufficient to permit deployment of the upstream workpiece support member 301_{U} of the crafting apparatus 300. Accordingly, a user may selectively disassemble the crafting apparatus assembly 50b by disconnecting the crafting apparatus 300 from the wall-mounted crafting apparatus support member 10 and then subsequently arrange crafting apparatus 300 directly upon the upper surface 75_{U} of the table 75a or connect the crafting apparatus 300 to another crafting apparatus support member 10 arranged upon the upper surface 75_{U} of the table 75a (as seen at FIG. 6A); in either configuration, after disassembling the crafting apparatus assembly 50b, the front surface 338 of the working portion 322 of the crafting apparatus 300 may be arranged proximate or in substantial alignment with the front surface 75_{F} of the table 75a in order to permit deployment of the upstream workpiece support member 301_{U} of the crafting apparatus 300 and the upstream workpiece support member 301_{U} with the wall surface 75b_{W} of the wall 75b.

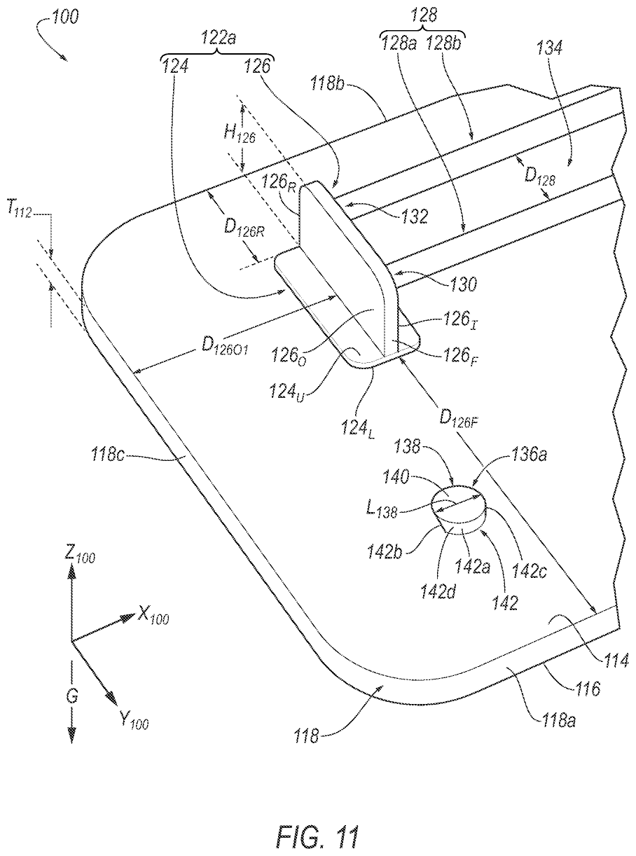

Referring to FIGS. 10-26, aspects of the crafting apparatus support member 100 are described. As seen at FIG. 10, the crafting apparatus support member 100 includes a substantially planar body 112. Like the substantially planar body 12 of the crafting apparatus support member 10 described above at FIGS. 1-9, the substantially planar body 112 includes an upper surface 114, a lower surface 116, and a side surface 118. The side surface 118 connects the upper surface 114 to the lower surface 116. Furthermore, the side surface 118 defines a thickness T₁₁₂ (see, e.g., FIG. 11) of the substantially planar body 112 that extends between the upper surface 114 and the lower surface 116.

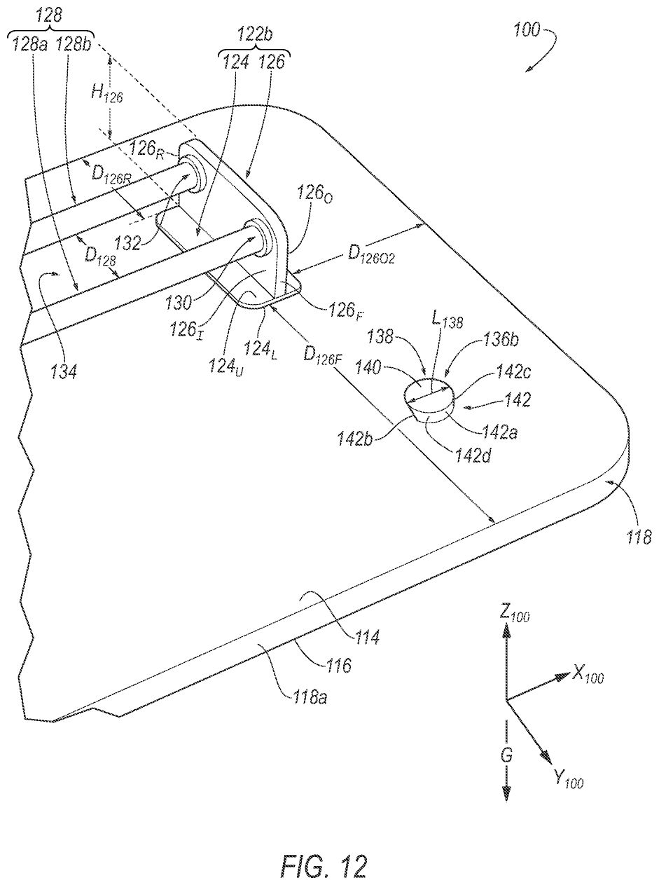

Furthermore, like substantially planar body 12 of the crafting apparatus support member 10 described above at FIGS. 1-9, the crafting apparatus support member 100 includes a workpiece retainer assembly 120 that is connected to the upper surface 114 of the substantially planar body 112. Like the workpiece retainer assembly of the crafting apparatus support member 10 described above at FIGS. 1-9, the workpiece retainer assembly 120 includes a pair of bracket members 122 defined by a first bracket member 122a (see also, e.g., FIG. 11) and a second bracket member 122b (see also, e.g., FIG. 12). Referring to FIGS. 11-12, each of the first bracket member 122a and the second bracket member 122b includes a base portion 124 and a flange portion 126.

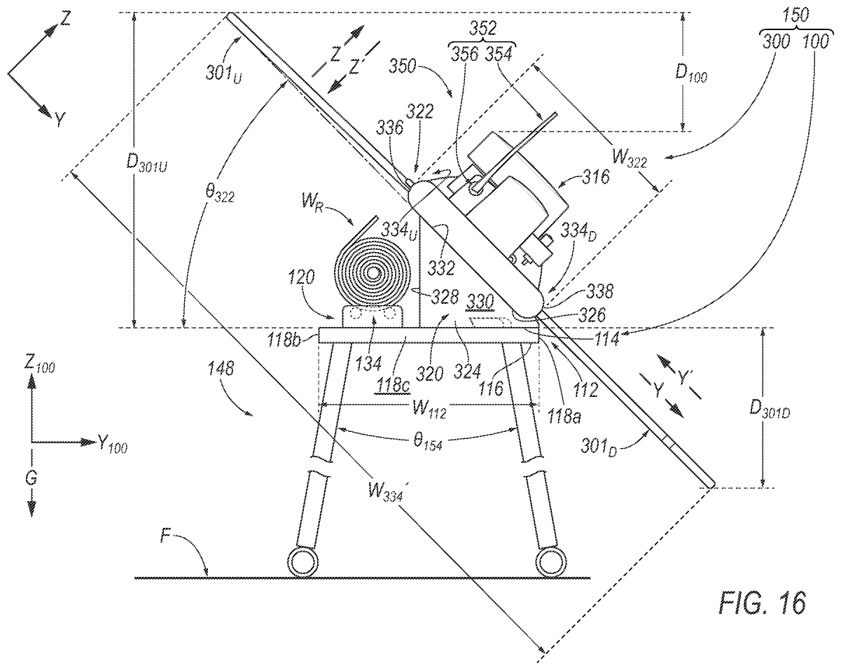

As seen at FIG. 10, the workpiece retainer assembly 120 also includes a pair of rod members 128 defined by a first rod member 128a and a second rod member 128b. Referring to FIGS. 11-12, each of the first rod member 128a and the second rod member 128b includes a first rod member end 130 and a second rod member end 132. Furthermore, a spacing between the first rod member 128a and the second rod member 128b defines a roll of workpiece-material-receiving gap 134 that is configured to, as seen at FIGS. 15-16, permit passage of a portion of the roll of workpiece material W R there-through while the first rod member 128a and the second rod member 128b axially support the roll of workpiece material W_{R} in the “Z Direction” (i.e., Z₁₀₀) of the “non-working” three dimensional X₁₀₀-Y₁₀₀-Z₁₀₀ Cartesian coordinate system.

Furthermore, like substantially planar body 12 of the crafting apparatus support member 10 described above at FIGS. 1-9, the crafting apparatus support member 100 includes one or more crafting apparatus interface portions 136. In some configurations, the one or more crafting apparatus interface portions 136 includes a pair of crafting apparatus interface portions. The pair of crafting apparatus interface portions 136 includes a first crafting apparatus interface portion 136a (as also seen at, e.g., FIG. 11) and a second crafting apparatus interface portion 136b (as also seen at, e.g., FIG. 12). Referring to FIGS. 11-12, each crafting apparatus interface portion 136a, 136b of the pair of crafting apparatus interface portions 136 includes a boss 138. The boss 138 of each crafting apparatus interface portion 136a, 136b includes an upper surface 140 and a side surface 142 connecting the upper surface 140 of the boss 138 of each crafting apparatus interface portion 1136a, 136b to the upper surface 114 of the substantially planar body 112.

The side surface 142 of each crafting apparatus interface portion 136a, 136b is further defined by a front side surface 142a and a rear side surface 142b arranged opposite the front side surface 142a. The side surface 142 of each crafting apparatus interface portion 136a, 136b is further defined by an outwardly-facing side surface 142c and an inwardly-facing side surface 142d arranged opposite the outwardly-facing side surface 142c.

The rear side surface 142b of the side surface 142 of the boss 138 of each crafting apparatus interface portion 136a, 136b extends from the upper surface 140 of the boss 138 to define a nose portion 144 of the boss 138 of each crafting apparatus interface portion 136a, 136b. The rear side surface 142b of the side surface 142 of the boss 138 of each crafting apparatus interface portion 136a, 136b and the upper surface 114 of the substantially planar body 112 may also define, as seen at FIG. 14A, a recessed region 146.

Referring to FIGS. 15-18, when the crafting apparatus 300 is selectively removably-connected to the crafting apparatus support member 100 as seen at FIGS. 14A-14C (which is similar to what is described above with respect to the crafting apparatus support member 10 at FIGS. 5A-5C), a crafting apparatus assembly is seen generally at 150. In some configurations, the crafting apparatus assembly 150 may further include the roll of workpiece material W_{R} arranged upon and supported by the workpiece retainer assembly 120.

As seen at FIGS. 10-13 and 15-18, the crafting apparatus support member 100 may further include a crafting apparatus support member management sub-assembly 148 that is attached to the lower surface 116 of the substantially planar body 112 of the crafting apparatus support member 100. With reference to FIG. 10, the crafting apparatus assembly 150 may further include a first end 148a of the crafting apparatus support member management sub-assembly 148 attached to the lower surface 116 of the substantially planar body 112 of the crafting apparatus support member 100 and a second end 148b of the crafting apparatus support member management sub-assembly 148 arranged upon an underlying ground surface or floor F.

As described above at FIGS. 1-9, the crafting apparatus support member 10 includes a plurality of surfaces that define angles, widths, lengths, depths, thicknesses, spacings, gaps, and the like. Aspects of the crafting apparatus support member 100 described above at reference numerals 112-146 also include a similar plurality of surfaces that define angles, widths, lengths, depths, thicknesses, spacings, gaps, and the like. Although such similar surfaces (associated with reference numerals 112-146 of the crafting apparatus support member 100) that define angles, widths, lengths, depths, thicknesses, spacings, gaps, and the like are not described above, such surfaces that define angles, widths, lengths, and the like are seen at FIGS. 10-18 whereby the reference numerals of such surfaces that define angles, widths, lengths, depths, thicknesses, spacings, gaps, and the like are increased by “100” (e.g., reference numeral 12 representing the substantially planar body of the crafting apparatus support member 10 is equivalent to reference numeral 112 representing the substantially planar body of the crafting apparatus support member 100) and are not repeated in the present written description in the interest of brevity.

Referring now to FIGS. 10-13 and 15-24, aspects of the crafting apparatus support member management sub-assembly 148, which is not included with the crafting apparatus support member 10 of FIGS. 1-9) are now described. With initial reference to FIG. 10, the crafting apparatus support member management sub-assembly 148 includes a pair of leg assemblies 152 defined by a first leg assembly 152a and a second leg assembly 152b. The components of the first leg assembly 152a and the second leg assembly 152b may be formed from any desirable material such as, for example, metal, plastic, or the like.

The first leg assembly 152a is connected to the lower surface 116 of the substantially planar body 112 and extends generally away from the lower surface 116 of the substantially planar body 112 in the “Z Direction” (i.e., Z₁₀₀) of the “non-working” three dimensional X₁₀₀-Y₁₀₀-Z₁₀₀ Cartesian coordinate system. Furthermore, the first leg assembly 152a is arranged near or proximate the first side surface 118c of the side surface 118 of the substantially planar body 112 that extends in the “Y Direction” (i.e., Y₁₀₀) of the “non-working” three dimensional X₁₀₀-Y₁₀₀-Z₁₀₀ Cartesian coordinate system.

The second leg assembly 152b is connected to the lower surface 116 of the substantially planar body 112 and extends generally away from the lower surface 116 of the substantially planar body 112 in the “Z Direction” (i.e., Z₁₀₀) of the “non-working” three dimensional X₁₀₀-Y₁₀₀-Z₁₀₀ Cartesian coordinate system. Furthermore, the second leg assembly 152b is arranged near or proximate the second side surface 118d of the side surface 118 of the substantially planar body 112 that extends in the “Y Direction” (i.e., Y₁₀₀) of the “non-working” three dimensional X₁₀₀-Y₁₀₀-Z₁₀₀ Cartesian coordinate system.

The first leg assembly 152a and the second leg assembly 152b may each include similar components. For example, each of the first leg assembly 152a and the second leg assembly 152b include a pair of leg members 154 including a first leg member 154a and a second leg member 154b. The first leg member 154a and the second leg member 154b include a proximal end 154a_{P}, 154b_{P} and a distal end 154a_{D}, 154b_{D}.

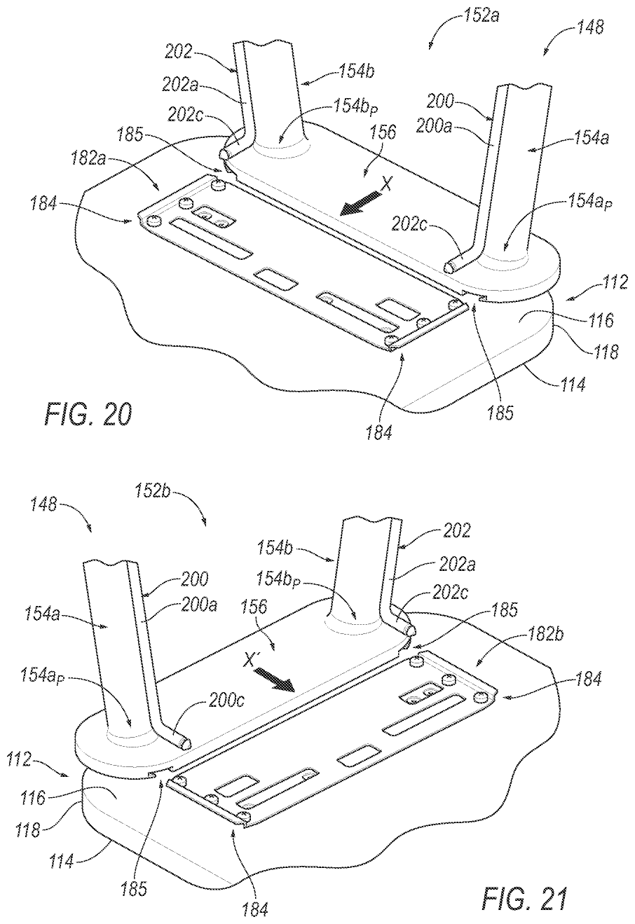

With reference to FIGS. 20-21, each of the first leg assembly 152a and the second leg assembly 152b may include a leg assembly base member 156. The proximal end 154a_{P}, 154b_{P} of each of the first leg member 154a and the second leg member 154b is attached to and respectively generally extend away from a leg assembly base member 156 in the “Z Direction” (i.e., Z₁₀₀) of the “non-working” three dimensional X₁₀₀-Y₁₀₀-Z₁₀₀ Cartesian coordinate system. Furthermore, in some configurations, both of the first leg member 154a and the second leg member 154b extend non-perpendicularly away from the leg assembly base member 156 generally in the “Z Direction” (i.e., Z₁₀₀) of the “non-working” three dimensional X₁₀₀-Y₁₀₀-Z₁₀₀ Cartesian coordinate system to define a leg spread angle θ₁₅₄ (see, e.g., FIGS. 10, 13, 15, and 16). As seen at FIGS. 13, 15, and 16, the leg spread angle θ₁₅₄ results in the distal end 154a_{D}, 154b_{D} of each of the first leg member 154a and the second leg member 154b being respectively arranged beyond respectively the front side surface 118a of the side surface 118 of the substantially planar body 112 and the rear side surface 118b of the side surface 118 of the substantially planar body 112 such that the distal end 154a_{D}, 154b_{D} of each of the first leg member 154a and the second leg member 154b are not arranged directly under the lower surface 116 of the substantially planar body 112. In some examples, the leg spread angle θ₁₅₄ may be approximately equal to 30°.

With reference to FIG. 10, yet even further, each of the first leg assembly 152a and the second leg assembly 152b may include a plurality of wheels 158. The plurality of wheels 158 includes a first pair of wheels 158a and a second pair of wheels 158b. The first pair of wheels 152a is defined by a first wheel 158a₁ and a second wheel 158a₂. The second pair of wheels 152b is defined by a first wheel 158b₁ and a second wheel 158b₂.

As seen at FIG. 10, the first wheel 158a1 of the first pair of wheels 158a is attached to the distal end 154a_{D} of the first leg member 154a of the first leg assembly 152a. The second wheel 158a2 of the first pair of wheels 158a is attached to the distal end 154b_{D} of the second leg member 154b of the first leg assembly 152a.

The first wheel 158b₁ of the second pair of wheels 158b is attached to the distal end 154a_{D} of the first leg member 154a of the second leg assembly 152b. The second wheel 158b2 of the second pair of wheels 158b is attached to the distal end 154b_{D} of the second leg member 154b of the second leg assembly 15ba.

The plurality of wheels 158 may permit a user to push, move, or relocate the crafting apparatus support member 100 relative to the underlying ground surface or floor F to a stowage area of the room (e.g., within a closet) when the crafting apparatus 300 (that may be selectively removably-connected to the crafting apparatus support member 100) is not being utilized by a user. In some configurations, at least one wheel 158a₁, 158a₂, 158b₁, 158b₂ of the plurality of wheels 158 may be a caster wheel. Furthermore, in other configurations, at least one wheel 158a₁, 158a₂, 158b₁, 158b₂ of the plurality of wheels 158 may also include a wheel lock 158_{L} (see, e.g., FIG. 10) that, when actuated, prevents rotation and/or swiveling of the wheel member 158.

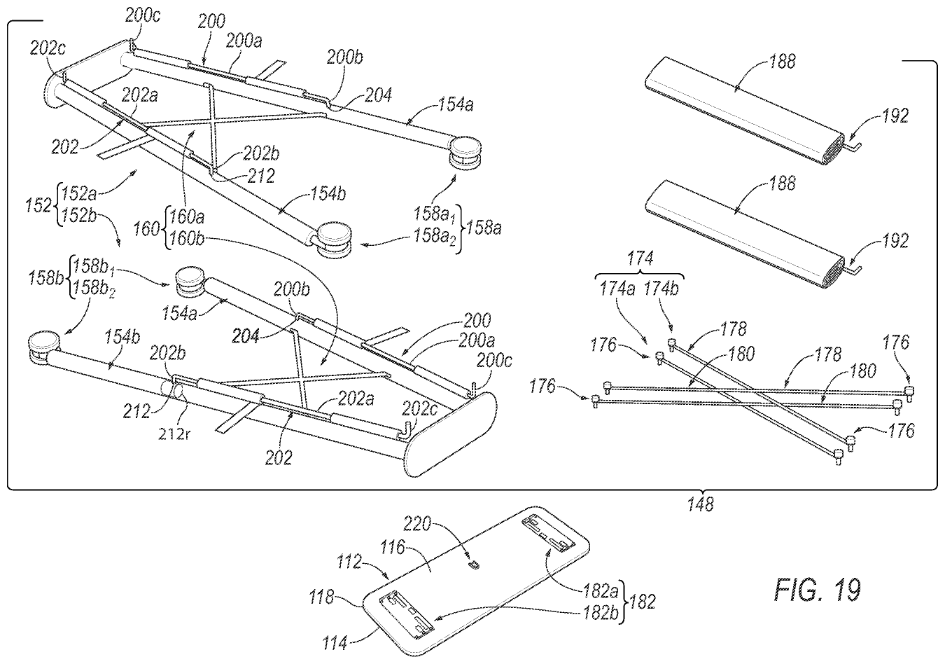

Referring to FIG. 19, in other examples, each of the first leg assembly 152a and the second leg assembly 152b respectively include a cross-bar assembly 160a, 160b that defines a pair of cross-bar assemblies 160 of the crafting apparatus support member management sub-assembly 148 that extend generally (as seen at, e.g., FIG. 10) in the “Y Direction” (i.e., Y₁₀₀) of the “non-working” three dimensional X₁₀₀-Y₁₀₀-Z₁₀₀ Cartesian coordinate system. Accordingly, the pair of cross-bar assemblies 160 and each cross-bar assembly 160a, 160b may qualified as, respectively, a “Y Direction” pair of cross-bar assemblies or a “Y Direction” cross-bar assembly. The pair of “Y Direction” cross-bar assemblies 160 includes a first “Y Direction” cross-bar assembly 160a attached to the first leg assembly 152a and a second “Y Direction” cross-bar assembly 160b attached to the second leg assembly 152b.

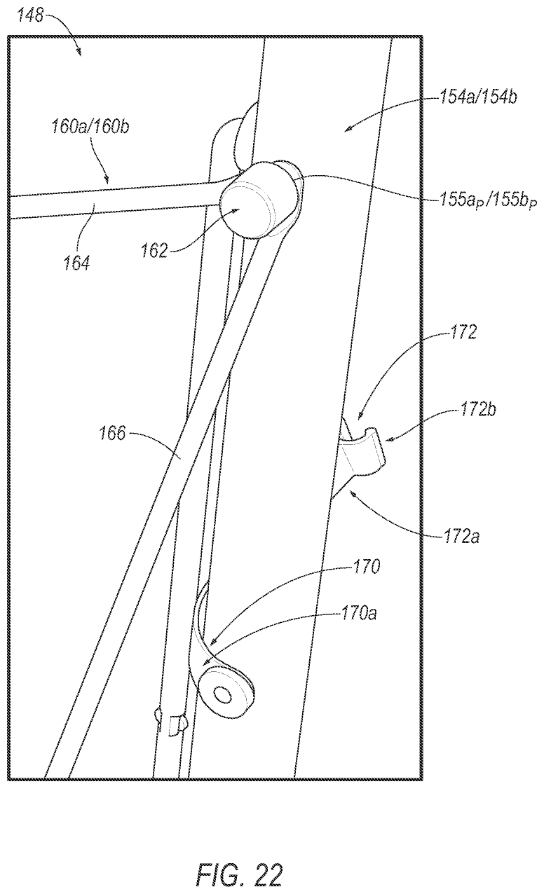

The first “Y Direction” cross-bar assembly 160a joins the first leg member 154a of the first leg assembly 152a to the second leg member 154b of the first leg assembly 152a. In some instances, each of the first leg member 154a and the second leg member 154b form fastener-receiving passages 155a_{P}, 155b_{P} (see, e.g., FIG. 22) that are configured to receive fasteners 162 that may extend from distal ends of, respectively, a first bar member 164 (see, e.g., FIG. 22) and a second bar member 166 (see, e.g., FIG. 22) of the first “Y Direction” cross-bar assembly 160a. The fasteners 162 may be, for example, thumbs screw fasteners; accordingly, the first “Y Direction” cross-bar assembly 160a may be joined to the first leg assembly 152a without tools in a user-friendly, “tool-free” fashion.

The second “Y Direction” cross-bar assembly 160b joins the first leg member 154a of the second leg assembly 152b to the second leg member 154b of the second leg assembly 152b. Furthermore, the first leg member 154a and the second leg member 154b is configured to permit attachment of the second “Y Direction” cross-bar assembly 160b to second first leg assembly 152b. In some instances, each of the first leg member 154a and the second leg member 154b form fastener-receiving passages 155a_{P}, 155b_{P} that are configured to receive fasteners 162 that may extend from distal ends of, respectively, a first bar member 164 and a second bar member 166 of the second “Y Direction” cross-bar assembly 160b. The fasteners 162 may be, for example, thumbs screw fasteners; accordingly, the second “Y Direction” cross-bar assembly 160b may be joined to the second leg assembly 152b without tools in a user-friendly, “tool-free” fashion.

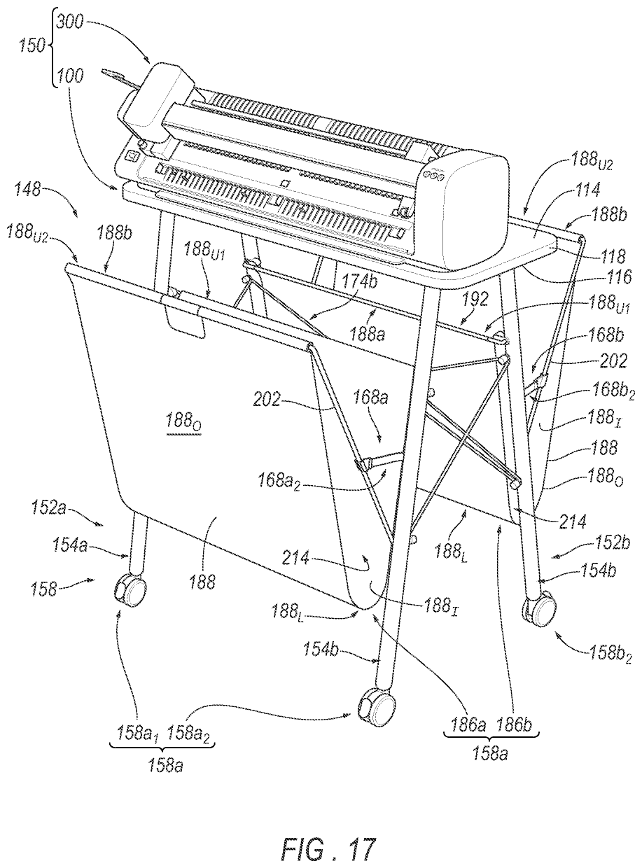

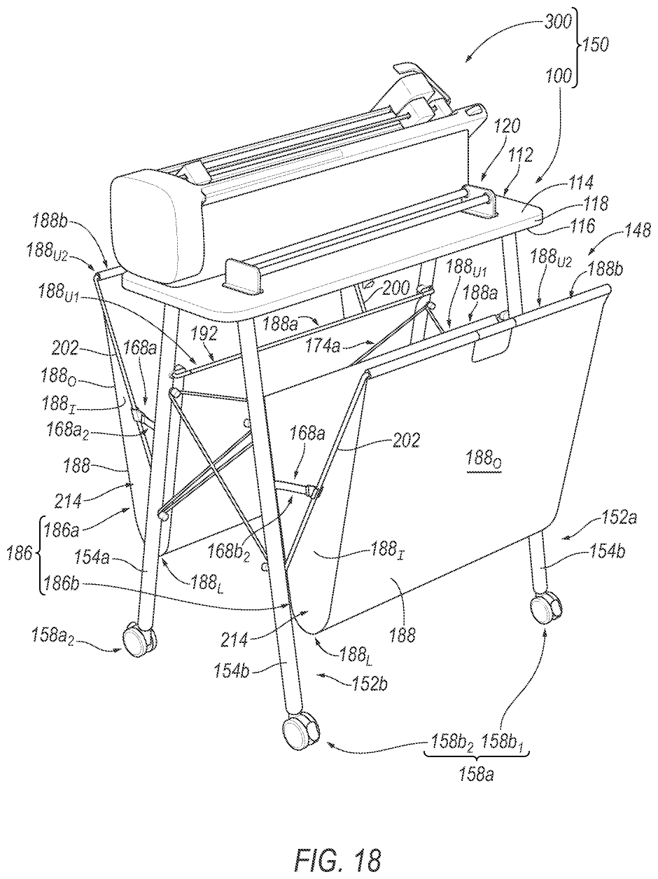

In yet other examples, each of the first leg assembly 152a and the second leg assembly 152b respectively includes a first pair of workpiece material catch basket breakaway retainers 168a (see, e.g., FIGS. 17-18) and a second pair of workpiece material catch basket breakaway retainers 168b (see, e.g., FIGS. 10 and 17-18). The first pair of workpiece material catch basket breakaway retainers 168a includes a first workpiece material catch basket breakaway retainer 168a₁ and a second workpiece material catch basket breakaway retainer 168a₂ (see, e.g., FIGS. 17-18). The second pair of workpiece material catch basket breakaway retainers 168b includes a first workpiece material catch basket breakaway retainer 168b₁ and a second workpiece material catch basket breakaway retainer 168b₂ (see, e.g., FIGS. 10 and 17-18).

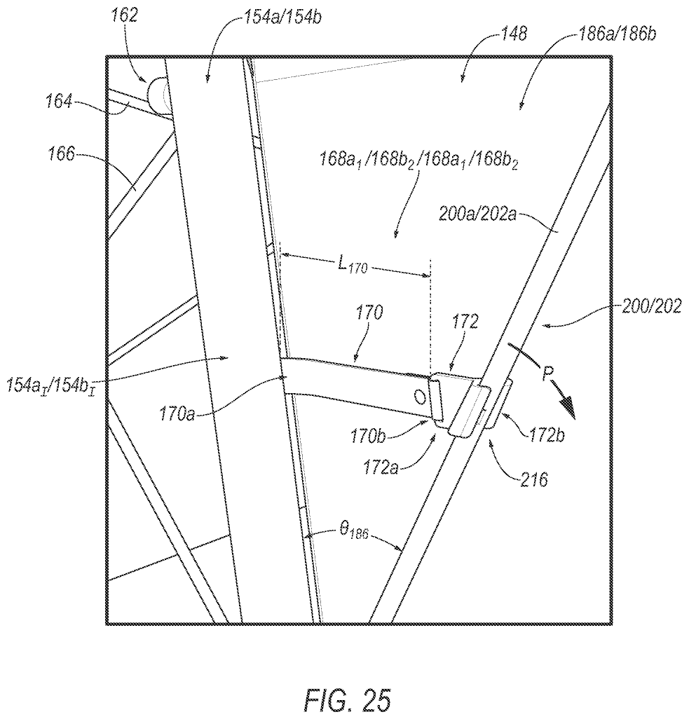

Referring to FIG. 25, each workpiece material catch basket breakaway retainer 168a₁, 168a₂, 168b₁, 168b₂ includes a substantially flexible strap portion 170 and a substantially rigid clip portion 172. The substantially flexible strap portion 170 may be formed from any desirable material, such as, for example, silicon. The substantially rigid clip portion 172 may be formed by any desirable plastic material. Because the crafting apparatus support member management sub-assembly 148 includes a total of four workpiece material catch basket breakaway retainers 168a₁, 168a₂, 168b₁, 168b₂, the crafting apparatus support member management sub-assembly 148 also includes four flexible strap portions 170 and four substantially rigid clip portions 172.

The first workpiece material catch basket breakaway retainer 168a₁ of the first pair of workpiece material catch basket breakaway retainers 168a is attached to an intermediate portion 154a₁ (see, e.g., FIG. 25) of the first leg member 154a of the first leg assembly 152a. The second workpiece material catch basket breakaway retainer 168a₂ of the first pair of workpiece material catch basket breakaway retainers 168a is attached to an intermediate portion 154b₁ (see, e.g., FIGS. 10 and 25) of the second leg member 154b of the first leg assembly 152a.

The first workpiece material catch basket breakaway retainer 168b₁ of the second pair of workpiece material catch basket breakaway retainers 168b is attached to an intermediate portion 154a₁ of the first leg member 154a of the second leg assembly 152b. The second workpiece material catch basket breakaway retainer 168b₂ of the second pair of workpiece material catch basket breakaway retainers 168b is attached to an intermediate portion 154b₁ of the second leg member 154b of the second leg assembly 15ba.

Referring to FIG. 25, a first end 170a of the substantially flexible strap portion 170 of each workpiece material catch basket breakaway retainer 168a₁, 168a₂, 168b₁, 168b₂ is attached to, respectively, the intermediate portion 154a₁, 154b₁ of the first leg member 154a or the second leg member 154b of the first leg assembly 152a or the second leg assembly 152b in any desirable fashion (e.g., with a fastener that extends into a fastener-receiving passage formed by the intermediate portion 154a₁, 154b₁ of the first leg member 154a or the second leg member 154b of the first leg assembly 152a or the second leg assembly 152b). A second end 170b of the substantially flexible strap portion 170 of each workpiece material catch basket breakaway retainer 168a₁, 168a₂, 168b₁, 168b₂ is attached to a first end 172a of the substantially rigid clip portion 172 in any desirable fashion (e.g., the second end 170b of the substantially flexible strap portion 170 may extend through a passage formed in the second end 170b of the substantially flexible strap portion 170 that is subsequently looped back toward and fastened-to (e.g., riveted-to) an intermediate region of the substantially flexible strap portion 170).

As seen at FIGS. 20-21, the first leg assembly 152a and the second leg assembly 152b may be attached to the lower surface 116 of the substantially planar body 112. Accordingly, in some configurations, the workpiece material catch basket breakaway retainer 168a₁, 168a₂, 168b₁, 168b₂ as seen at FIG. 25 may be attached to the first leg assembly 152a and the second leg assembly 152b after the first leg assembly 152a and the second leg assembly 152b are attached to the lower surface 116 of the substantially planar body 112.

In other examples, each of the first leg assembly 152a and the second leg assembly 152b respectively include a cross-bar assembly 174a (see, e.g., FIGS. 10, 18 and 19), 174b (see, e.g., FIGS. 17 and 19) that defines a pair of cross-bar assemblies 174 of the crafting apparatus support member management sub-assembly 148 that extend generally in the “X Direction” (i.e., X₁₀₀) of the “non-working” three dimensional X₁₀₀-Y₁₀₀-Z₁₀₀ Cartesian coordinate system; accordingly, the pair of cross-bar assemblies 174 and each cross-bar assembly 174a, 174b may qualified as, respectively, an “X Direction” pair of cross-bar assemblies or a “Y Direction” cross-bar assembly. The pair of “Y Direction” cross-bar assemblies 174 includes a first “Y Direction” cross-bar assembly 174a attached to one of the leg members 154a, 154b of the first leg assembly 152a and a second “X Direction” cross-bar assembly 174b attached to one of the leg members 154a, 154b of the second leg assembly 152b.

The first “X Direction” cross-bar assembly 174a may be alternatively referred to as a downstream cross-bar assembly 174a that joins the first leg member 154a of the first leg assembly 152a to the second leg member 154b of the second leg assembly 152b. In some instances, in a substantially similar manner as described above at FIG. 22, each of the first leg member 154a and the second leg member 154b form fastener-receiving passages 155a_{P}, 155b_{P} that are configured to receive fasteners 176 (see, e.g., FIG. 19) that may extend from distal ends of, respectively, a first bar member 178 (see, e.g., FIG. 19) and a second bar member 180 (see, e.g., FIG. 19) of the first “X Direction” cross-bar assembly 174a. The fasteners 176 may be, for example, thumbs screw fasteners; accordingly, the first “X Direction” cross-bar assembly 174a may be joined to the first leg assembly 152a without tools in a user-friendly, “tool-free” fashion.

The second “X Direction” cross-bar assembly 174b may be alternatively referred to as an upstream cross-bar assembly 174b that joins the first leg member 154a of the second leg assembly 152b to the second leg member 154b of the second leg assembly 152b. Furthermore, the first leg member 154a and the second leg member 154b is configured to permit attachment of the second “X Direction” cross-bar assembly 174b to second first leg assembly 152b. In some instances, each of the first leg member 154a and the second leg member 154b form fastener-receiving passages 154a_{P}, 154b_{P} that are configured to receive fasteners 176 that may extend from distal ends of, respectively, a first bar member 178 and a second bar member 180 of the second “X Direction” cross-bar assembly 174b. The fasteners 176 may be, for example, thumbs screw fasteners; accordingly, the second “X Direction” cross-bar assembly 174b may be joined to the second leg assembly 152b without tools in a user-friendly, “tool-free” fashion.

As seen at FIG. 19, the crafting apparatus support member management sub-assembly 148 may further include a pair of leg assembly base member interface brackets 182 that are attached to the lower surface 116 of the of the substantially planar body 112. The pair of leg assembly base member interface brackets 182 may include a first leg assembly base member interface bracket 182a (see also, e.g., FIG. 20) and a second leg assembly base member interface bracket 182b (see also, e.g., FIG. 21).

Referring to FIGS. 20-21, each of the first leg assembly base member interface bracket 182a and the second leg assembly base member interface bracket 182b may include one or more protrusions, connector snaps, one-way fasteners, flanges 184 or the like. Furthermore, the leg assembly base member 156 of each of the first leg assembly 152a and the second leg assembly 152b may define one or more corresponding passages or channels 185 that permit slidable-attachment of, respectively, the leg assembly base member 156 to the first leg assembly 152a according to the direction of arrow X (in the “X Direction” (i.e., X₁₀₀) of the “non-working” three dimensional X₁₀₀-Y₁₀₀-Z₁₀₀ Cartesian coordinate system) and the leg assembly base member 156 to the second leg assembly 152b according to the direction of arrow X′ (in the “X Direction” (i.e., X₁₀₀) of the “non-working” three dimensional X₁₀₀-Y₁₀₀-Z₁₀₀ Cartesian coordinate system). Accordingly, the first leg assembly base member interface bracket 182a and the second leg assembly base member interface bracket 182b permit respective attachment of the first leg assembly 152a and the second leg assembly 152b to the lower surface 116 of the substantially planar body 112.

Referring to FIG. 10, the crafting apparatus support member management sub-assembly 148 may further include one or more catch basket assemblies 186. The one or more catch basket assemblies 186 may include a downstream catch basket assembly 186a and an upstream catch basket assembly 186b.

Each of the downstream catch basket assembly 186a and the upstream catch basket assembly 186b includes a body of anti-static material 188. The body of anti-static material 188 includes a first end 188a (see, e.g., FIGS. 10, 17, 18, and 23) and a second end 188b (see, e.g., FIGS. 10, 17, 18, and 24). The body of anti-static material 188 may include one or more materials including a static-reducing material or charge-collecting material. In some instances, the body of anti-static material 188 may include a fabric material that is interwoven with copper wiring. The function of the body of anti-static material 188 will be explained in greater detail in the following disclosure. In various embodiments, the body of anti-static material 188 includes multiple layers of material. For example, the anti-static material 188 of the catch baskets may include an outer fabric material, an intermediate foam-type material (such as an ethylene-vinyl acetate foam material), and an inner anti-static fabric (e.g., a fabric material interwoven with electrically conductive material). The inner and outer fabric materials may be different fabric materials. The ethylene-vinyl acetate foam material may have a thickness of about 1 millimeter, thus imparting sufficient structure to the anti-static material 188 to prevent or at least inhibit the formation of wrinkles and/or creases in the anti-static material 188. The various layers of the anti-static material 188 may be laminated or non-laminated. In various embodiments, the anti-static material includes layers of fabric, such as cotton, between the aforementioned layers.

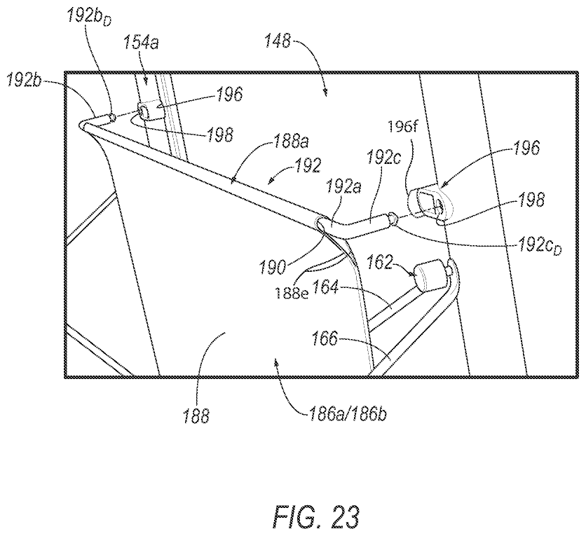

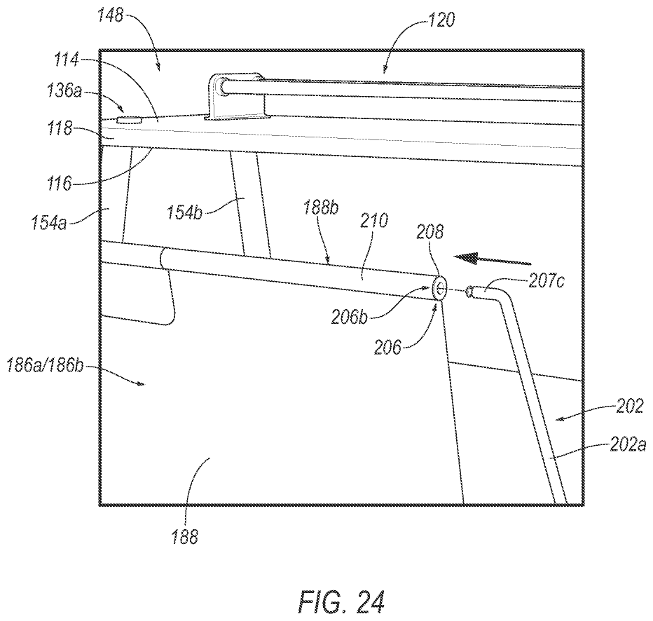

Referring to FIGS. 17-19 and 23, each of the downstream catch basket assembly 186a and the upstream catch basket assembly 186b further includes a non-pivoting catch basket bar, which may be referred to as a “non-pivoting” catch basket bar, which are seen generally at 192. Referring to FIG. 23, the non-pivoting catch basket bar 192 includes: (1) an intermediate portion 192a extending in the “X Direction” (i.e., X₁₀₀) of the “non-working” three dimensional X₁₀₀-Y₁₀₀-Z₁₀₀ Cartesian coordinate system; (2) a first portion 192b that extends substantially perpendicularly from a first end of the intermediate portion 192a and in the “Y Direction” (i.e., Y₁₀₀) of the “non-working” three dimensional X₁₀₀-Y₁₀₀-Z₁₀₀ Cartesian coordinate system; and (3) a second portion 192c that extends substantially perpendicularly from a second end of the intermediate portion 192a and in the “Y Direction” (i.e., Y₁₀₀) of the “non-working” three dimensional X₁₀₀-Y₁₀₀-Z₁₀₀ Cartesian coordinate system. With continued reference to FIG. 23, the intermediate portion 192a is configured to extend though a passageway 190 formed by the first end 188a of the body of anti-static material 188. Both of the first portion 192b of the non-pivoting catch basket bar 192 the second portion 192c of the non-pivoting catch basket bar 192 are not arranged within the passageway 190 formed by the first end 188a of the body of anti-static material 188.

The first leg member 154a of the first leg assembly 152a and the second leg member 154b of the second leg assembly 152b are configured to permit attachment of the non-pivoting catch basket bar 192 to each of the first leg assembly 152a and the second leg assembly 152b. In some instances, each of the first leg member 154a of the first leg assembly 152a and the second leg member 154b of the second leg assembly 152b respectively include a non-pivoting catch bar mounting member 196 including a passageway 198 that is configured to permit selective removable attachment of at least a distal end 192b D of the first portion 192b of the non-pivoting catch basket bar 192 to the first leg member 154a of the first leg assembly 152a and at least a distal end 192c D of the second portion 192c of the non-pivoting catch basket bar 192 to the second leg member 154b of the second leg assembly 152b. The distal end 192b_{D}, 192c_{D} of each of the first portion 192b of the non-pivoting catch basket bar 192 and the second portion 192c of the non-pivoting catch basket bar 192 may include, for example, a one-way fastener (e.g., a “Christmas tree” fastener) having a narrow neck portion and a tapering head. In some configurations, the distal end 192b_{D} of the first portion 192b of the non-pivoting catch basket bar 192 and the distal end 192c_{D} of the second portion 192c of the non-pivoting catch basket bar 192 may respectively extend through the non-pivoting catch bar mounting members 196 and through a passageway (not shown) formed by, respectively, each of the first leg member 154a of the first leg assembly 152a and the second leg member 154b of the second leg assembly 152b. In various embodiments, and with reference to FIG. 23, one or more of the non-pivoting catch basket bar mounting members 196 includes a flange 196f or a lip protruding from an inward edge thereof and configured to engage a lateral edge 188e of anti-static material 188. Said differently, the flange 196f may constrain movement of the anti-static material 188, and may thus prevent or at least inhibit the anti-static material 188 from becoming inadvertently compressed/pinched between the non-pivoting catch basket bar mounting member 196 and the non-pivoting catch basket bar 192.

Each of the downstream catch basket assembly 186a and the upstream catch basket assembly 186b further include a pair of pivoting catch basket bars defined by a first pivoting catch basket bar 200 (see, e.g., FIGS. 18-21 and 25) and a second pivoting catch basket bar 202 (see, e.g., FIGS. 10,17-21, and 24-26). Accordingly, in some configurations, the crafting apparatus support member management sub-assembly 148 may include two first pivoting catch basket bars 200 and two second pivoting catch basket bar 202 for a total of four pivoting catch basket bars.

The first pivoting catch basket bar 200 is configured to include an intermediate portion 200a (see, e.g., FIGS. 19-21, 25), a lower portion 200b (see, e.g., FIG. 19), and an upper portion 200c (see, e.g., FIGS. 19-21). The intermediate portion 200a of the first pivoting catch basket bar 200 is configured to be pivotally-movable relative to the first leg member 154a of the first leg assembly 152a and extends generally in the “Z Direction” (i.e., Z₁₀₀) of the “non-working” three dimensional X₁₀₀-Y₁₀₀-Z₁₀₀ Cartesian coordinate system.

The lower portion 200b of the first pivoting catch basket bar 200 extends substantially perpendicularly from a first end of the intermediate portion 200a and in the “Y Direction” (i.e., Y₁₀₀) of the “non-working” three dimensional X₁₀₀-Y₁₀₀-Z₁₀₀ Cartesian coordinate system. Furthermore, the lower portion 200b of the first pivoting catch basket bar 200 is configured to be disposed within a passageway 204 (see, e.g. FIG. 19) formed by the first leg member 154a of the first leg assembly 152a. Upon arranging the lower portion 200b of the first pivoting catch basket bar 200 within the passageway 204 formed by the first leg member 154a of the first leg assembly 152a, the lower portion 200b of the first pivoting catch basket bar 200 is rotatably-joined to the first leg member 154a of the first leg assembly 152a.

The upper portion 200c of the first pivoting catch basket bar 200 extends substantially perpendicularly from a second end of the intermediate portion 200a and in the “Y Direction” (i.e., Y₁₀₀) of the “non-working” three dimensional X₁₀₀-Y₁₀₀-Z₁₀₀ Cartesian coordinate system. With reference to FIG. 24 (as described in a similar fashion with respect to the upper portion 202c of the second pivoting catch basket bar 202), the upper portion 200c of the first pivoting catch basket bar 200 is connected to a first end of the body of anti-static material 188 that defines the downstream catch basket assembly 186a.

Referring to FIG. 24, each of the downstream catch basket assembly 186a and the upstream catch basket assembly 186b further include a tube-shaped body 206 having a first end 206a and a second end 206b. The tube-shaped body 206 is extend though a passageway 208 formed by the second end 188b of the body of anti-static material 188 that defines the downstream catch basket assembly 186a.

Furthermore, as seen at FIG. 24, the tube-shaped body 206 defines a passageway 210 that extends through the tube-shaped body 206 from the first end 206a of the tube-shaped body 206 toward the second end 206b of the tube-shaped body 206. At the first end 206a of the tube-shaped body 206, the passageway 210 is configured to receive the upper portion 200c of the first pivoting catch basket bar 200. Upon arranging the upper portion 200c of the first pivoting catch basket bar 200 within the passageway 210 formed by the tube-shaped body 206 for connecting the upper portion 200c of the first pivoting catch basket bar 200 to the passageway 210 formed by the tube-shaped body 206, the upper portion 200c of the first pivoting catch basket bar 200 may be non-rotatbly-disposed within the passageway 208 that extends from the first end 206a of the tube-shaped body 206.

The second pivoting catch basket bar 202 is configured to include an intermediate portion 202a (see, e.g., FIGS. 19-21, 24-25), a lower portion 202b (FIG. 19), and an upper portion 202c (see, e.g., FIGS. 19-21, 24, 26). The intermediate portion 202a of the second pivoting catch basket bar 202 is configured to be pivotally-movable relative to the second leg member 154b of the second leg assembly 152b and extends generally in the “Z Direction” (i.e., Z₁₀₀) of the “non-working” three dimensional X₁₀₀-Y₁₀₀-Z₁₀₀ Cartesian coordinate system.

The lower portion 202b of the second pivoting catch basket bar 202 extends substantially perpendicularly from a first end of the intermediate portion 202a and in the “Y Direction” (i.e., Y₁₀₀) of the “non-working” three dimensional X₁₀₀-Y₁₀₀-Z₁₀₀ Cartesian coordinate system. Furthermore, the lower portion 202b of the second pivoting catch basket bar 202 is configured to be disposed within a passageway 212 (see, e.g., FIG. 19) formed by the second leg member 154b of the second leg assembly 152b. Upon arranging the lower portion 202b of the second pivoting catch basket bar 202 within the passageway 212 formed by the second leg member 154b of the second leg assembly 152b, the lower portion 202b of the second pivoting catch basket bar 202 is rotatably-joined to the second leg member 154b of the second leg assembly 152b. In various embodiments, and with reference to FIG. 19, a reinforced retention member 212r may be disposed within the leg member (e.g., leg member 154b) at or adjacent to the passageway 212 and may be configured to receive the lower portion 202b of the second pivoting catch basket bar 202. This reinforced retention member 212r may provide additional structural reinforcement for the rotating/pivoting coupling. Further, the reinforced retention member 212r may have an outer surface that is configured to engage and/or complement an inner surface of the leg member, and the surface area of this engagement may improve the robustness, reliability, and/or dependability of the pivoting coupling. Although the reinforced retention member 212r is only shown arranged within the disposed within the leg member 154b of the second leg assembly 152b at FIG. 19, a reinforced retention member 212r may be similarly disposed within one, several, or all of the leg members 154a, 154b of the first leg assembly 152a and second leg assembly 152b for similarly providing additional structural reinforcement for the rotating/pivoting coupling.

The upper portion 202c of the second pivoting catch basket bar 202 extends substantially perpendicularly from a second end of the intermediate portion 202a and in the “Y Direction” (i.e., Y₁₀₀) of the “non-working” three dimensional X₁₀₀-Y₁₀₀-Z₁₀₀ Cartesian coordinate system. As will be described below at FIG. 24, the upper portion 202c of the second pivoting catch basket bar 202 is connected to the second end 188b of the body of anti-static material 188 that defines the downstream catch basket assembly 186a.

As described above and as seen at FIG. 24, tube-shaped body 206 extends though the passageway 208 formed by the second end 188b of the body of anti-static material 188 that defines the downstream catch basket assembly 186a. At the second end 206b of the tube-shaped body 206, the passageway 210 of the tube-shaped body 206 is configured to receive the upper portion 202c of the second pivoting catch basket bar 202. Upon arranging the upper portion 202c of the second pivoting catch basket bar 202 within the passageway 210 formed by the tube-shaped body 206 for connecting the upper portion 202c of the second pivoting catch basket bar 202 to the passageway 210 formed by the tube-shaped body 206, the upper portion 202c of the second pivoting catch basket bar 202 may be non-rotatably-disposed within the passageway 208 that extends from the second end 206b of the tube-shaped body 206.

As described above: (1) the non-pivoting catch basket bar 192; (2) the first pivoting catch basket bar 200; and (3) the second pivoting catch basket bar 202 are utilized for connecting (in the “X Direction” (i.e., X₁₀₀) of the “non-working” three dimensional X₁₀₀-Y₁₀₀-Z₁₀₀ Cartesian coordinate system) the body of anti-static material 188 of the downstream catch basket assembly 186a to: (A) the first leg member 154a of the first leg assembly 152a; and (B) the second leg member 154b of the second leg assembly 152b. Although the connection of the upstream catch basket assembly 186b to the first leg member 154a of the first leg assembly 152a and the second leg member 154b of the second leg assembly 152b is not described above, similar components (i.e., the non-pivoting catch basket bar 192, the first pivoting catch basket bar 200, the second pivoting catch basket bar 202) are utilized for similarly connecting (in the “X Direction” (i.e., X₁₀₀) of the “non-working” three dimensional X₁₀₀-Y₁₀₀-Z₁₀₀ Cartesian coordinate system) the body of anti-static material 188 of the upstream catch basket assembly 186b to: (A) the first leg member 154a of the first leg assembly 152a; and (B) the second leg member 154b of the second leg assembly 152b.

With reference to FIGS. 17-18, when the body of anti-static material 188 of the downstream catch basket assembly 186a is connected to the first leg member 154a of the first leg assembly 152a and the second leg member 154b of the second leg assembly 152b, functionally, the body of anti-static material 188 generally form a U-shape having: (1) a first upper end 188_{U1} that is generally defined by the first end 188a of the body of anti-static material 188 and is non-movably-arranged between the first leg member 154a of the first leg assembly 152a and the second leg member 154b of the second leg assembly 152b; (2) a second upper end 188_{U2} that is generally defined by the second end 188b of the body of anti-static material 188 and is movably-disposed in the “Y Direction” (i.e., Y₁₀₀) of the “non-working” three dimensional X₁₀₀-Y₁₀₀-Z₁₀₀ Cartesian coordinate system relative the first leg member 154a of the first leg assembly 152a and the second leg member 154b of the second leg assembly 152b; and (3) a lower end 188_{L} arranged between the first upper end 188_{U1} and the second upper end 188_{U2}.

Furthermore, the body of anti-static material 188 may further include an outwardly-facing surface portion 188_{O} extending between the first upper end 188_{U1} and the second upper end 188_{U2} and an inwardly-facing surface portion 188_{I} extending between the first upper end 188_{U1} and the second upper end 188_{U2}. The innerwardly-facing surface 1881 may define a valley 214 of the U-shape body of anti-static material 188.

The inner surface 188_{U1} that defines the valley 214 of the U-shape body of anti-static material 188 is configured to collect, for example, one or more severed-and-worked-on workpiece material portions W as the severed-and-worked-on workpiece material portions W is/are ejected from the working surface 334 of the crafting apparatus 300. Because the body of anti-static material 188 of the downstream catch basket assembly 186a may include one or more materials including a static-reducing material or charge-collecting material, the downstream catch basket assembly 186a may be configured to reduce a build-up of static electricity associated with the one or more severed-and-worked-on workpiece material portions W as: (1) the one or more severed-and-worked-on workpiece material portions W come into contact with the working surface 334 during operation of the crafting apparatus 300; and (2) are subsequently deposited into and come in contact with the body of anti-static material 188 of the downstream catch basket assembly 186a. More specifically, because the body of anti-static material 188 of the downstream catch basket assembly 186a is indirectly connected to the underlying ground surface or floor F by way of plurality of wheels 158 that support the pair of leg assemblies 152 of the crafting apparatus support member management sub-assembly 148, any build-up of static electricity associated with the one or more severed-and-worked-on workpiece material portions W is discharged by electrically grounding the one or more severed-and-worked-on workpiece material portions W the moment the one or more severed-and-worked-on workpiece material portions W comes into contact with the body of anti-static material 188 of the downstream catch basket assembly 186a. In this way, the downstream catch basket assembly 186a may reduce the build-up of static electricity associated with the one or more severed-and-worked-on workpiece material portions W, which could possibly, in some circumstances, affect the operation of one or more components of the crafting apparatus 300.

Furthermore, either of the downstream catch basket assembly 186a and the upstream catch basket assembly 186b may be arranged in a deployed orientation (as seen at, e.g., FIGS. 17-18) and stowed orientation (not shown). When arranged in the deployed orientation, for example, the downstream catch basket assembly 186b is configured to collect, for example, one or more severed-and-worked-on workpiece material portions W as the severed-and-worked-on workpiece material portions W is/are ejected from the working surface 334 of the crafting apparatus 300. Furthermore, the upstream catch basket assembly 186b may function in a manner to stow ancillary items such as worked-upon or non-worked upon workpieces W, tools associated with the crating apparatus 300, and the like.

When the either of the downstream catch basket assembly 186a and the upstream catch basket assembly 186b is arranged in the stowed orientation, the downstream catch basket assembly 186b, for example, is not configured to collect, for example, one or more severed-and-worked-on workpiece material portions W as the severed-and-worked-on workpiece material portions W is/are ejected from the working surface 334 of the crafting apparatus 300. When either of the downstream catch basket assembly 186a and the upstream catch basket assembly 186b is arranged in the stowed orientation, intermediate portion 200a, 202a of the pivoting catch basket bars 200, 202 of the either of the downstream catch basket assembly 186a and the upstream catch basket assembly 186b may arranged adjacent or proximate the leg members 154a, 154b of the leg assemblies 152a, 152b.

Movement of either of the downstream catch basket assembly 186a and the upstream catch basket assembly 186b to/from the deployed orientation and stowed orientation generally arises from pivoting the lower portion 200b, 202b of the pivoting catch basket bars 200, 202 (that are arranged within passageways 204, 212 formed by the leg members 154a, 154b of the leg assemblies 152a, 152b) relative the leg members 154a, 154b of the leg assemblies 152a, 152b. When arranged in the deployed orientation, the pivoting movement is limited by a length L₁₇₀ of the substantially flexible strap portion 170 of each workpiece material catch basket breakaway retainer 168a₁, 168a₂, 168b₁, 168b₂ that is attached to a first end 172a of the substantially rigid clip portion 172.

As seen at FIG. 25, a second end 172b of any of the substantially rigid clip portions 172 is configured to be removably-connected to any of the pivoting catch basket bars 200, 202 of either of the downstream catch basket assembly 186a and the upstream catch basket assembly 186b. When either of the downstream catch basket assembly 186a and the upstream catch basket assembly 186b is arranged in a fully deployed orientation according to a fully deployed catch basket assembly deployment angle θ₁₈₆ (whereby the length L₁₇₀ of the substantially flexible strap portion 170 of any of the workpiece material catch basket breakaway retainer 168a₁, 168a₂, 168b₁, 168b₂ is fully maximized or fully stretched), if a user pivots P (see, e.g., FIG. 25) the pivoting catch basket bars 200, 202 of the either of the downstream catch basket assembly 186a and the upstream catch basket assembly 186b at an angle that is greater than the fully deployed catch basket assembly deployment angle θ₁₈₆, the second end 172b of any of the substantially rigid clip portions 172 is configured to release any of the pivoting catch basket bars 200, 202 of either of the downstream catch basket assembly 186a and the upstream catch basket assembly 186b therefrom. Accordingly, the removable disconnection of the second end 172b of any of the substantially rigid clip portions 172 from any of the pivoting catch basket bars 200, 202 of either of the downstream catch basket assembly 186a and the upstream catch basket assembly 186b provides a catch basket breakaway portion 216 (see, e.g., FIG. 25) of the crafting apparatus support member management sub-assembly 148.

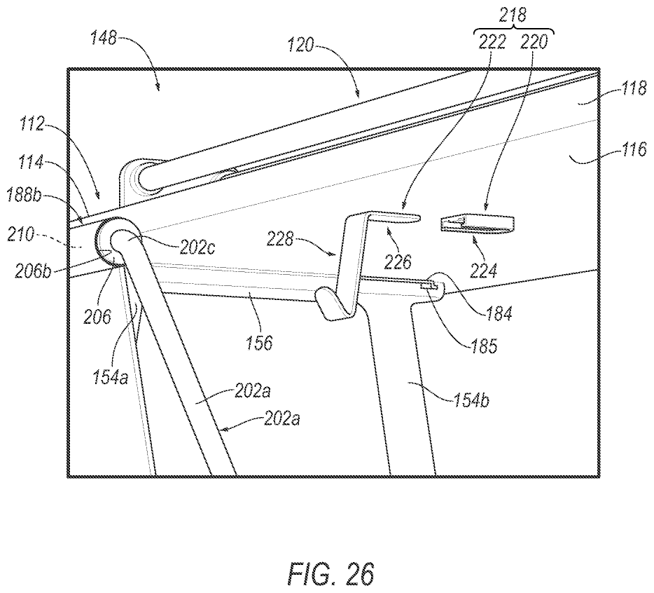

Referring to FIG. 26, the crafting apparatus support member management sub-assembly 148 may further include a workpiece support mat stowage assembly 218 that is configured to stow a “large form” workpiece support mat W_{M} (see, e.g., FIG. 28) that may be configured to support a preconfigured “large form” workpiece W (see also, e.g., FIG. 28). The workpiece support mat stowage assembly 218 may include a bracket portion 220 and a mat retainer portion 222. In some configurations, the bracket portion 220 defines a channel 224. In some examples, the mat retainer portion 222 includes a bracket interface portion 226 and a mat hook portion 228 extending from the bracket interface portion 226 generally in the “Z Direction” (i.e., Y₁₀₀) of the “non-working” three dimensional X₁₀₀-Y₁₀₀-Z₁₀₀ Cartesian coordinate system.

The bracket portion 220 may be non-removably-secured to the lower surface 116 of the substantially planar body 112. Accordingly, when an opening W_{MO} (see, e.g., FIG. 28) of the “large form” workpiece support mat W_{M} is interfaced with the mat hook portion 228 of the workpiece support mat stowage assembly 218, the “large form” workpiece support mat W_{M} may be stowed: (1) below the lower surface 116 of the substantially planar body 112; (2) between the downstream cross-bar assembly 174a and the upstream cross-bar assembly 174b; and (3) above the underlying ground surface or floor F.

In some implementations, the bracket interface portion 226 of the mat retainer portion 222 is slidbly-interfaced with the channel 224 of the bracket portion 220 in the “Y Direction” (i.e., Y₁₀₀) of the “non-working” three dimensional X₁₀₀-Y₁₀₀-Z₁₀₀ Cartesian coordinate system for removably-connecting the mat retainer portion 222 to the bracket portion 220. Removable-connection of the mat retainer portion 222 to the bracket portion 220 permits a user to selectively-disconnect the mat retainer portion 222 to the bracket portion 220, or, alternatively, permits the mat retainer portion 222 to break-away from the bracket portion 220 if a sufficient pulling force is applied to the mat retainer portion 222 directly, or, indirectly if a user pulls the “large form” workpiece support mat W_{M} with a sufficient amount of pulling force that does not arise in removal of the “large form” workpiece support mat W_{M} from the mat hook portion 228.

The present disclosure provides various methods for assembling and/or using the crafting apparatus support members 10, 100 50a or the crafting apparatus assemblies 50a, 50b, 150. Said differently, the various assembly details described above generally provide method steps for assembling the crafting apparatus support members 10, 100 or the crafting apparatus assemblies 50a, 50b, 150. Further, the details described above pertaining to the interaction and/or engagement between a crafting apparatus 300 and the crafting apparatus support members 10, 100 generally provide methods steps for assembling and/or using a crafting apparatus 300. Accordingly, methods for assembling and using the various structural components described herein are also within the scope of the present disclosure.

Referring now to FIGS. 26-28, and as described above at FIGS. 4, 6A-9, 13, and 15-18, the crafting apparatus 300 includes an angled (see, e.g., angle θ₃₂₂ at FIGS. 6A-7, 13, and 15-16) working surface (see, e.g., working surface 334) and workpiece management components that are utilized prior to and/or during the act of conducting “work” upon a workpiece W. Because the angled θ₃₂₂ working surface 334 is not parallel to an underlying ground surface or floor F and/or an upper surface 16, 116 of the crafting apparatus support members 10, 100 that supports the crafting apparatus 300, the workpiece management components prevent the workpiece W from sliding off of the angled θ₃₂₂ working surface 334 as a result of a gravitational pull G on the workpiece W that would otherwise cause the angled θ₃₂₂ working surface 334 to undesirably function as a workpiece slide. Additionally, the present disclosure relates to a crafting apparatus 300 having a “door-less” and/or a “large-form” configuration, as described in greater detail below.

Furthermore, the crafting apparatus 300 may be selectively reconfigured in order to conduct work on a workpiece W that is derived from at least two different types of workpiece sources (see, e.g., a first type of workpiece source W R at FIGS. 4, 6A-7, 13, and 15-16 and a second type of workpiece source W+W_{M} seen at FIG. 28). In a first example, with reference to FIGS. 4, 6A-7, 13, and 15-16, the first type of workpiece source W_{R} may be a roll of workpiece material whereby a portion of a length of workpiece material W reeled from the roll of workpiece material W_{R} may be interfaced with the crafting apparatus 300 while a remainder of the roll of workpiece material defined by the roll of workpiece material W_{R} is not interfaced with the working surface 334 of the crafting apparatus 300. In another example, with reference to FIG. 28, the second type of workpiece source W+W_{M} may not be derived from a roll, but, rather, from a relatively “large” workpiece W having substantially flat, preconfigured shape (having, e.g., a length W_{L} and a width W_{W}) that may or may not be supported by a support mat W_{M}).

Yet even further, because the crafting apparatus 300 is designed to be “door-less”, a plurality of components of the crafting apparatus 300 that conduct “work” upon the workpiece W are always exposed to the surrounding environment. Accordingly, the crafting apparatus 300 includes an aesthetically-pleasing design whereby structure (e.g., one or both of a front door and a rear door) are not included in the design of the crafting apparatus 300, and, as a result, does not cover or obfuscate the plurality of components of the crafting apparatus 300 that conduct “work” upon the workpiece W even when the crafting apparatus 300 is not conducting “work” upon the workpiece W.

With reference to FIGS. 4, 6A-9, 13, 15-18, and 26-28, the crafting apparatus 300 includes a plurality of components such as, for example: a printing device 312; a cutting device 314; a carriage 316; and a rail 318. The plurality of components of the crafting apparatus 300 cooperate for conducting “work” upon a workpiece W.

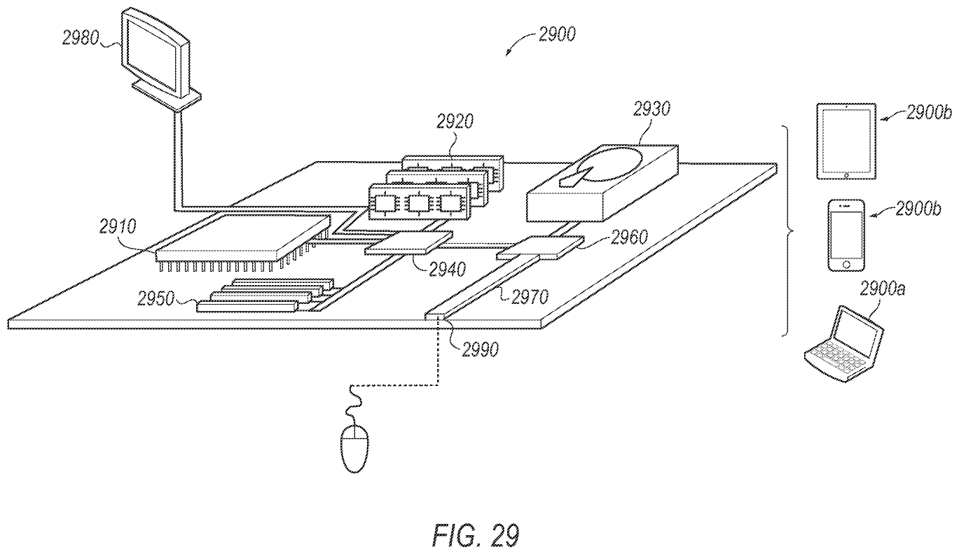

The term “work” may include, but is not limited to, any number of tasks/functions performed by one or a combination of the printing device 312 and the cutting device 314 that are secured to the carriage 316. The carriage 316 is movably-disposed according to the direction of arrows X, X′ (in, e.g., a “working” three dimensional X-Y-Z Cartesian coordinate system) upon the rail 318. The movement X, X′ of the carriage 316 along the rail 318 may be controlled by a motor (not shown) that may receive, for example, actuation signals from a central processing unit (CPU) (see, e.g., 2900 in FIG. 29); the motor may drive one or more cables and belts (not shown) for causing movement X, X′ of the carriage 316 relative the rail 318.

In some configurations, the CPU 2900 is a component of the crafting apparatus 300. In other configurations, the CPU 2900 is associated with a laptop computer (see, e.g., laptop computer 2900a in FIG. 29) that is communicatively-coupled to the crafting apparatus 300. In yet other configurations, the CPU 2900 is associated with a smart phone, tablet computer, or the like (see, e.g., smart phone or tablet computer 2900b in FIG. 29) that is communicatively-coupled to the crafting apparatus 300.

In an example, the “work” may include a “cutting operation” that functionally includes contact of a blade of the cutting device 314 with the workpiece W as the workpiece W is moved in the Y, Y′ feed directions by one or more components (see, e.g., active drive rollers 360/384) of the crafting apparatus 300. The “work” conducted by the cutting device 314 arises from one or a combination of: (1) movement of the cutting device 314 according to the direction of arrows Z, Z′ in, e.g., the “working” three dimensional X-Y-Z Cartesian coordinate system relative to, for example, one or more of the carriage 316 and the rail 318; and (2) movement of the workpiece W in forward or backward feed directions according to the direction or arrows Y, Y′ in the “working” three dimensional X-Y-Z Cartesian coordinate system relative to, for example, one or more of the carriage 312 and the rail 318. The movement Z, Z′ of the cutting device 314 and the workpiece W (by way of rotation of the active drive rollers 360/384) in the feed directions Y, Y′ may be controlled by one or more motors (not shown) that receive actuation signals from the central processing unit CPU 2900 thereby causing, for example, rotation of the one or more components (e.g., the active drive rollers 360/384) of the crafting apparatus 300.

In some implementations, the blade of the cutting device 314 partially or fully penetrates a thickness of the workpiece W according to the direction of the arrow Z′. Although the cutting device 314 may include a blade (such as, e.g., a straight blade, a castoring blade, a rotary blade, a serrated edge blade, an embossing tool, a marking tool or the like), other cutters may be selectively coupled to the cutting device 314. Other cutters may include, for example, a laser, an electrically-powered rotary cutter, or the like.

In other examples, the “work” includes a “printing operation”. The “printing operation” may including depositing ink from a pen or nozzle of the printing device 312 onto the workpiece W.

The crafting apparatus 300 may conduct “work” in a manner that provides a combo operation such as a “print-and-cut operation”. The “print-and-cut operation” may, in some instances, be executed as a “print-then-cut operation” such that the “printing operation” is conducted prior to the “cutting operation”.

In some implementations, the workpiece W includes any desirable shape, size, geometry or material composition. The shape/geometry may include, for example, a width W_{W} and a length W_{L}. In some instances, the length W_{L} of the workpiece W is not preconfigured as a result of, for example, reeling a desired amount of workpiece material from the roll of workpiece material W_{R}. In other examples, however, the length W_{L} of the workpiece W is preconfigured as a result of, for example, a user obtaining a preconfigured workpiece having a predetermined length W_{L} and a predetermined width W_{W}. In some instances, the width W_{W} of the workpiece W may be greater than or approximately equal to twelve inches (12″/30.5 centimeters). In other examples, the width W_{W} of the workpiece W may be greater than or approximately equal to twenty-five inches (25″/63.5 centimeters).

Because the crafting apparatus 300 may conduct “work” on different workpiece sources as described above, the crafting apparatus 300 may be structurally reconfigured. In an example, a user may elect to firstly conduct “work” on a relatively “large”, preconfigured workpiece W, which may call for configuring the crafting apparatus 300 by deploying workpiece support arms (see, e.g., 301_{D}, 301_{U} at FIGS. 7, 16, and 28); then at a later time, the user may elect to secondly conduct “work” on a workpiece W that is derived from the roll of workpiece material W_{R}, which would then call for configuring the crafting apparatus 300 by stowing the workpiece support arms 301_{D}, 301_{U} so the workpiece support arms 301_{D}, 301_{U} do not interfere with reeling the workpiece from the roll of workpiece material W_{R} as seen at FIGS. 27A-27C.

As seen at FIG. 28, the workpiece W (and, in some instances, a workpiece support mat W_{M}) may include a relatively “large” square or rectangular shape having a predetermined length W_{L} and width W_{W}. In some examples, the dimensions W_{L}, W_{W} of the relatively “large” square or rectangular workpiece W and/or the workpiece support mat W_{M} may be approximately equal to twenty-four inches (24″/61.0 centimeters) by twenty-four inches (24″/61.0 centimeters). In other examples, the dimensions W_{L}, W_{W} of the relatively “large” square or rectangular workpiece W and/or the workpiece support mat W_{M} may be approximately equal to twenty-four inches (24″/61.0 centimeters) by forty-eight inches (48″/122.0 centimeters). In yet another example, the dimensions W_{L}, W_{W} of the relatively “large” square or rectangular workpiece W and/or the workpiece support mat W M may be approximately equal to forty-eight inches (48″/122.0 centimeters) by forty-eight inches (48″/122.0 centimeters).

Alternatively, the shape of the relatively “large” square or rectangular workpiece W may include non-square or non-rectangular shapes, such as, for example, circular shapes, triangular shapes or the like. The material composition of the workpiece W may include paper-based (e.g., paperboard or cardboard) and/or non-paper-based products (e.g., vinyl, foam, rigid foam, cushioning foam, plywood, veneer, balsawood or the like). Nevertheless, although various implementations of workpiece material composition may be directed to paper, vinyl or foam-based products, the material composition of the workpiece W is not limited to a particular material and may include any cuttable material.

In some implementations, the crafting apparatus 300 may be utilized in a variety of environments when conducting “work” on the workpiece W. For example, the crafting apparatus 300 may be located within one's home and may be connected to an external computer system (e.g., a desktop computer, a laptop computer 2900a, a smart phone, tablet computer 2900b, a dedicated/non-integral/dockable [standalone] controller device which is not a general purpose computer, or the like) such that a user may utilize software that may be run by the external computer system 2900a, 2900b in order for the crafting apparatus 300 to conduct “work” on the workpiece W. In another example, the crafting apparatus 300 may be referred to as a “stand alone system,” that, in some implementations, integrally includes one or more of an on-board monitor, an on-board keyboard, an on-board CPU 2900 including a processor, memory and the like. In such an implementation, the crafting apparatus 300 may operate independently of any external computer systems (e.g., the laptop 2900a, smart phone, or tablet 2900b) in order to permit the crafting apparatus 300 to conduct “work” on the workpiece W.

The crafting apparatus 300 may be implemented to have any desirable size, shape or configuration. For example, the crafting apparatus 300 may be sized to conduct “work” on a relatively “large” workpiece W (e.g., plotting paper that is reeled from the roll of workpiece material W_{R}); accordingly, when the workpiece W is said to be relatively “large”, the crafting apparatus 300 may be said to be a “large-form” crafting apparatus 300 in order to accommodate relatively “large” workpieces W. Alternatively, the crafting apparatus 300 may be configured to conduct “work” on a relatively small workpiece W, which may be defined by a preconfigured shape with fixed dimensions W_{L}, W_{W}. Furthermore, even though the crafting apparatus 300 may conduct “work” on relatively “large” workpieces W (such as, e.g., plotting paper that is reeled from the roll of workpiece material W_{R}), the crafting apparatus 300, as will be described in the following disclosure, may be said to be a “portable”. Accordingly, the crafting apparatus 300 may be sufficiently sized to conduct “work” on relatively “large” workpieces W while permitting a user to easily carry/move the “large-form” crafting apparatus 300 from one's home to, for example, a friend's home where the friend may be hosting, for example, a “scrap-booking party.”

As described above at FIGS. 1-26, the crafting apparatus 300 is arranged upon one of the crafting apparatus support members 10, 100. The crafting apparatus support members 10, 100 may support crafting apparatus 300 so that the workpiece W is free to flow onto and off of working surface 334 without coming into contact with the crafting apparatus support members 10, 100, which would thereby otherwise hinder the free flow of the workpiece W. In some configurations, a front edge 18a, 118a of the crafting apparatus support members 10, 100 may align or be closely aligned with a front surface 338 of a working portion 322 of the crafting apparatus 300. In some implementations, the crafting apparatus support members 10, 100 include a holder 20, 120 for supporting and/or feeding a roll workpiece material W_{R} as it is fed onto working surface 334 of the crafting apparatus 300. In other implementations, the crafting apparatus support members 10, 100 may include a lock feature (see, e.g., the crafting apparatus interface portion 36, 136 at FIGS. 5A-5C and 14A-14C) that corresponds to a lock feature (see, e.g. the one or more boss-receiving cavities 325 at FIGS. 5A-5C, 14A-14C, and 27) formed by, for example, the lower surface 324 of the base portion 320 of the crafting apparatus 300 to selectively lock crafting apparatus 300 on to the crafting apparatus support members 10, 100; this lock feature 36, 136/325 may be configured to stabilize crafting apparatus 300 when it is placed on the crafting apparatus support members 10, 100, thereby preventing the crafting apparatus 300 from falling off of the crafting apparatus support members 10, 100.

As described above, the crafting apparatus support members 10, 100 may be arranged over the underlying ground surface or floor F whereby the upper surface 14, 114 of the crafting apparatus support members 10, 100 may be parallel to the underlying ground surface or floor F. The crafting apparatus 300 is arranged upon and supported by the upper surface 14, 114 of the crafting apparatus support members 10, 100. As explained above and as will be described in the following disclosure, the crafting apparatus 300 includes an angled θ₃₂₂ working surface 334 that is not parallel to the underlying ground surface or floor F and/or the upper surface 14, 114 of the crafting apparatus support members 10, 100.

In addition to the upper surface 14, 114, the crafting apparatus support members 10, 100 also includes the front edge 18a, 118a, a rear edge 18b, 118b, a first side edge 18c, 118c, and a second side edge 18d, 118d. Furthermore, the crafting apparatus support members 10, 100 may be defined by: a length L₁₂, L₁₁₂ extending between the first side edge 18c, 118c and the second side edge 18d, 118d; and a width W₁₂, W₁₁₂ extending between the front edge 18a, 118a, the rear edge 18b, 118b.

As described above, the crafting apparatus support members 10, 100 also defines a “non-working” three dimensional X₁₀-Y₁₀-Z₁₀/X₁₀₀-Y₁₀₀-Z₁₀₀ Cartesian coordinate system. The “Z Direction” (i.e., Z₁₀/Z₁₀₀) of the “non-working” three dimensional X₁₀-Y₁₀-Z₁₀/X₁₀₀-Y₁₀₀-Z₁₀₀ Cartesian coordinate system is orthogonal to the upper surface 14, 114 of the crafting apparatus support members 10, 100. The “Y Direction” (i.e., Y₁₀/Y₁₀₀) of the “non-working” three dimensional X₁₀-Y₁₀-Z₁₀/X₁₀₀-Y₁₀₀-Z₁₀₀ Cartesian coordinate system extends in the direction of the width W₁₂, W₁₁₂ of the crafting apparatus support members 10, 100. The “X Direction” (i.e., X₁₀/X₁₀₀) of the “non-working” three dimensional X₁₀-Y₁₀-Z₁₀/X₁₀₀-Y₁₀₀-Z₁₀₀ Cartesian coordinate system extends in the direction of the length L₁₂, L₁₁₂ of the crafting apparatus support members 10, 100.

The “Z Direction (i.e., the Z₁₀-axis/Z₁₀₀-axis)” of the “non-working” three dimensional X₁₀-Y₁₀-Z₁₀/X₁₀₀-Y₁₀₀-Z₁₀₀ Cartesian coordinate system is aligned and parallel with a gravitational axis defined by arrow G that generally illustrates a gravitational pull with respect to the underlying ground surface or floor F. Accordingly, because the “Z Direction (i.e., the Z-axis)” of the “working” three dimensional X-Y-Z Cartesian coordinate system is angularly offset from the “Z Direction” of the “non-working” three dimensional X₁₀-Y₁₀-Z₁₀/X₁₀₀-Y₁₀₀-Z₁₀₀ Cartesian coordinate system by the angle θ₃₂₂, the “Z Direction (i.e., the Z-axis)” of the “working” three dimensional X-Y-Z Cartesian coordinate system is not aligned with, and traverses, the gravitational axis defined by the arrow G. Stated differently, the gravitational axis defined by the arrow G and the Z-axis of the “working” three dimensional X-Y-Z Cartesian coordinate system are not parallel and transverse one another. Although the crafting apparatus 300 includes a working surface 334 that defines the angle θ₃₂₂ is described above to be interfaced with either of the crafting apparatus support members 10, 100, other exemplary crafting apparatuses may be configured to be removably-attached to the crafting apparatus support members 10, 100 in a substantially similar manner as described above. In some implementations, for example, the working surface of such exemplary crafting apparatuses may not include the angle θ₃₂₂; in such configurations, the working surface of such crafting apparatuses may be substantially parallel to the upper surface 14, 114 of the crafting apparatus support members 10, 100. Accordingly, in such configurations, the “Z Direction (i.e., the Z-axis)” of the “working” three dimensional X-Y-Z Cartesian coordinate system may not be angularly offset from the “Z Direction” of the “non-working” three dimensional X₁₀-Y₁₀-Z₁₀/X₁₀₀-Y₁₀₀-Z₁₀₀ Cartesian coordinate system, the “Z Direction (i.e., the Z-axis)” of the “working” three dimensional X-Y-Z Cartesian coordinate system. Therefore, in such configurations, the “Z Direction (i.e., the Z-axis)” of the “working” three dimensional X-Y-Z Cartesian coordinate system may be aligned with, and traverse, the gravitational axis defined by the arrow G. Stated differently, the gravitational axis defined by the arrow G and the Z-axis of the “working” three dimensional X-Y-Z Cartesian coordinate system may be parallel and transverse one another.

The crafting apparatus 300 may be positioned anywhere upon the upper surface 14, 114 of the crafting apparatus support members 10, 100. However, in some instances, the crafting apparatus 300 may be positioned near one of the edges 18a/118a, 18b/118b, 18c/118c, 18d/118d (e.g., the front edge 18a/118a) of the crafting apparatus support members 10, 100. Arrangement of the crafting apparatus 300 near the front edge 18a, 118a of the crafting apparatus support members 10, 100 permits deployment of a downstream workpiece support member (see, e.g., downstream support arm 301_{D}) of the crafting apparatus 300 at a distance (see, e.g., D_{301D} at FIGS. 7 and 16) below the upper surface 14, 114 of the crafting apparatus support members 10, 100. Furthermore, the crafting apparatus 300 also permits deployment of an upstream workpiece support member (see, e.g., upstream support arm 301_{U}) of the crafting apparatus 300 at a distance (see, e.g., D_{301U}) above the upper surface 14, 114 of the crafting apparatus support members 10, 100.

The crafting apparatus 300 includes a base portion 320 and a working portion 322. The base portion 320 is configured for arrangement upon the upper surface 14, 114 of the crafting apparatus support members 10, 100. The working portion 322 is disposed upon or connected to the base portion 320. The working portion 322 includes the printing device 312 and/or the cutting device 314, the carriage 316, and the rail 318; accordingly, the working portion 322 conducts the “work” on the workpiece W according to the “working” three dimensional X-Y-Z Cartesian coordinate system as described above. As will be described in the following disclosure, the working portion 322 may include one or more workpiece management components that may include, for example, one or more pinch-roller arms 346, a cam actuator (not shown) connected to the one or more pinch roller arms 346, an actuator lever 352 connected to the cam actuator, one or more workpiece stoppers 386 connected to the actuator lever 352, and a plurality of workpiece suction channels 394 that may be actuated in response to rotation of the actuator lever 352.

The base portion 320 is generally defined by a lower surface 324, an upper surface 326, and a rear surface 328. The rear surface 328 extends away from a first end of the lower surface 324 at approximately a right angle or 90° angle, according to various embodiments. Furthermore, the rear surface 328 extends away from a first end of the upper surface 326 at an acute angle, according to various embodiments. Yet even further, a second end of the upper surface 326 extends away from a second end of the lower surface 324 at the acute angle θ₃₂₂, according to various embodiments. Collectively, the lower surface 324, the upper surface 326, and the rear surface 3328 generally define a side surface 30 of the base portion 320 having a substantially triangular shape (e.g., the base portion 320 may have a “wedge-like” shape).

The working portion 322 is generally defined by a lower surface 332, an upper surface 334, a rear surface 336, and a front surface 338. The lower surface 332 of the working portion 322 is disposed adjacent or connected to the upper surface 326 of the base portion 320. Accordingly, when the crafting apparatus 300 is arranged upon the upper surface 14, 114 of the crafting apparatus support members 10, 100, the angular arrangement (i.e., at the acute angle θ₃₂₂) of the upper surface 334 of the working portion 322 relative to the lower surface 324 of the base portion results in the “working” three dimensional X-Y-Z Cartesian coordinate system of the working portion 322, the working portion 322 being angularly offset from the “non-working” three dimensional X₁₀-Y₁₀-Z₁₀/X₁₀₀-Y₁₀₀-Z₁₀₀ Cartesian coordinate system that is referenced from the upper surface 14, 114 of the crafting apparatus support members 10, 100. In various embodiments, the angular arrangement of the upper surface 326 of the base portion 320 relative the lower surface 324 of the base portion 320 results in the “working” three dimensional X-Y-Z Cartesian coordinate system of the working portion 322 being angularly offset (i.e., at the acute angle θ₃₂₂) from the “non-working” three dimensional X₁₀-Y₁₀-Z₁₀/X₁₀₀-Y₁₀₀-Z₁₀₀ Cartesian coordinate system that is referenced from the upper surface 14, 114 of the crafting apparatus support members 10, 100.

The upper surface 334 is arranged at the angle (i.e., at the acute angle θ₃₂₂) relative to a horizontal plane established by the lower surface 324 of the base portion 320 being arranged upon the upper surface 14, 114 of the crafting apparatus support members 10, 100. In some implementations, the angle θ₃₂₂ may be approximately equal to 45°. In various embodiments, the angle θ₃₂₂ is between approximately 30° and approximately 60°. In various embodiments, the angle θ₃₂₂ is between approximately 20° and approximately 70°. In various embodiments, the angle θ₃₂₂ may be any value between 0° and approximately 90°. As used in this context only, the term “approximately” means plus or minus 2°. Accordingly, in configurations where the angle θ₃₂₂ increases, a width defined by the lower surface 324 of the base portion 320 decreases. Therefore, an increase in the angle θ₃₂₂ may reduce the “footprint” of the base portion 320 while still providing a sufficiently “large” upper surface 334 in the Y, Y′ feed directions for supporting relatively “large” workpieces W while minimizing the space that the base portion 320 takes up on the upper surface 14, 114 of the crafting apparatus support members 10, 100.

The upper surface 334 of the working portion 322 may be alternatively referred to as “a working surface” on which the workpiece W rests as well as for manipulation in the Y, Y′ feed directions by one or more workpiece management components of the crafting apparatus 300. Furthermore, the rail 318 may be supported by and elevated away from the working surface 334 by a first rail support member 334a and a second rail support member 334b that extends away from the working surface 334 according to the Z direction of the three dimensional X-Y-Z Cartesian coordinate system.

The working surface 334 provides support for the workpiece W both before (i.e., upstream of) and after (i.e., downstream of) a point of contact with the printing device 312 and/or the cutting device 314. The working surface 334 also acts as a surface against which a tool, such as, for example, the cutting blade of the cutting device 314, presses against the workpiece W according to the Z′ direction of the three dimensional X-Y-Z Cartesian coordinate system. Accordingly, the working surface 334 may be further defined by an upstream portion 334_{U} of the working surface 334, a downstream portion 334_{D} of the working surface 334, and an intermediate portion 334_{I} of the working surface 334, which is located between the upstream portion 334_{U} of the working surface 334 and the downstream portion 334_{D} of the working surface 334.

The upstream portion 334_{U} of the working surface 334 is generally where, for example, a portion of a length of the workpiece W may be initially interfaced with the crafting apparatus 300. The intermediate portion 334_{I} of the working surface 334 is generally where, for example, the printing device 312 and the cutting device 314 (that are moveably supported by the carriage 316) conducts “work” on the workpiece W. The downstream portion 334_{D} of the working surface 334 is generally where, for example, the portion of the length of the workpiece W is moved after conducting “work” on the workpiece W and/or where the workpiece W is ejected or removed from the crafting apparatus 300 after the “work” is conducted on the workpiece W.

FIG. 29 is schematic view of an example computing device 2900 that may be used to implement the systems and methods described in this document. The components 2910, 2920, 2930, 2940, 2950, and 2960 shown at FIG. 29, their connections and relationships, and their functions, are meant to be exemplary only, and are not meant to limit implementations of the inventions described and/or claimed in this document.

The computing device 2900 includes a processor 2910, memory 2920, a storage device 2930, a high-speed interface/controller 2940 connecting to the memory 2920 and high-speed expansion ports 2950, and a low speed interface/controller 2960 connecting to a low speed bus 2970 and a storage device 2930. Each of the components 2910, 2920, 2930, 2940, 2950, and 2960, are interconnected using various busses, and may be mounted on a common motherboard or in other manners as appropriate. The processor 2910 can process instructions for execution within the computing device 2900, including instructions stored in the memory 2920 or on the storage device 2930 to display graphical information for a graphical user interface (GUI) on an external input/output device, such as display 2980 coupled to high speed interface 2940. In other implementations, multiple processors and/or multiple buses may be used, as appropriate, along with multiple memories and types of memory. Also, multiple computing devices 2900 may be connected, with each device providing portions of the necessary operations (e.g., as a server bank, a group of blade servers, or a multi-processor system).

The memory 2920 stores information non-transitorily within the computing device 2900. The memory 2920 may be a computer-readable medium, a volatile memory unit(s), or non-volatile memory unit(s). The non-transitory memory 2920 may be physical devices used to store programs (e.g., sequences of instructions) or data (e.g., program state information) on a temporary or permanent basis for use by the computing device 2900. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 2930 is capable of providing mass storage for the computing device 2900. In some implementations, the storage device 2930 is a computer-readable medium. In various different implementations, the storage device 2930 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 2920, the storage device 2930, or memory on processor 2910.

The high speed controller 2940 manages bandwidth-intensive operations for the computing device 2900, while the low speed controller 2960 manages lower bandwidth-intensive operations. Such allocation of duties is exemplary only. In some implementations, the high-speed controller 2940 is coupled to the memory 2920, the display 2980 (e.g., through a graphics processor or accelerator), and to the high-speed expansion ports 2950, which may accept various expansion cards (not shown). In some implementations, the low-speed controller 2960 is coupled to the storage device 2930 and a low-speed expansion port 2990. The low-speed expansion port 2990, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 2900 may be implemented in a number of different forms, as shown in the figure. For example, it may be implemented in one or a combination of the crafting apparatus 300 and a laptop computer 2900a.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or to production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The schematic flow chart diagrams included herein are generally set forth as logical flow chart diagrams. As such, the depicted order and labeled steps are indicative of one or more embodiments of the presented method. The steps recited in any of the method or process descriptions may be executed in any order and are not necessarily limited to the order presented, unless otherwise specified. Furthermore, any reference to singular includes plural embodiments, and any reference to more than one component or step may include a singular embodiment or step. Elements and steps in the figures are illustrated for simplicity and clarity and have not necessarily been rendered according to any particular sequence. Other steps and methods may be conceived that are equivalent in function, logic, or effect to one or more steps, or portions thereof, of the illustrated method.

Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown. Furthermore, no element, component, or method step in the present disclosure is intended to be dedicated to the public regardless of whether the element, component, or method step is explicitly recited in the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. A crafting apparatus support member that supports a crafting apparatus, wherein a lower surface of the crafting apparatus includes one or more boss-receiving cavities, the crafting apparatus support member comprising:
a substantially planar body portion having an upper surface, a lower surface, and a side surface connecting the upper surface to the lower surface; and
one or more crafting apparatus interface portions having a boss portion extending from the upper surface of the substantially planar body portion that are configured to be interfaced with the one or more boss-receiving cavities of the crafting apparatus.

2. The crafting apparatus support member of claim 1 further comprising:
a workpiece retainer assembly connected to the upper surface of the substantially planar body portion.

3. The crafting apparatus support member of claim 1, wherein the workpiece retainer assembly includes:
a pair of rod members including by a first rod member and a second rod member that a spaced apart by a distance for forming a workpiece-material-receiving-gap; and
a pair of bracket members that support the pair of rod members away from the upper surface of the substantially planar body portion at a height, wherein the pair of bracket members include a first bracket member and a second bracket member.

4. The crafting apparatus support member of claim 1, wherein the lower surface of the substantially planar body portion is configured to be supported by a table.

5. The crafting apparatus support member of claim 1, wherein the side surface of the substantially planar body portion is configured to be connected to a wall.

6. The crafting apparatus support member of claim 1, wherein the lower surface of the substantially planar body portion is configured to be supported by a crafting apparatus support member management sub-assembly.

7. The crafting apparatus support member of claim 6, wherein the crafting apparatus support member management sub-assembly includes a pair of leg assemblies defined by a first leg assembly and a second leg assembly.

8. The crafting apparatus support member of claim 7, wherein the crafting apparatus support member management sub-assembly includes one or more catch basket assemblies connected to one or both of the first leg assembly and the second leg assembly.

9. The crafting apparatus support member of claim 8, wherein the one or more catch basket assemblies include a body of anti-static material.

10. The crafting apparatus support member of claim 1, wherein the crafting apparatus includes a working surface angle that defines a working three dimensional Cartesian coordinate system, wherein the upper surface of the substantially planar body portion defines a non-working three dimensional Cartesian coordinate system that is angularly offset from the working surface angle of the crafting apparatus.

11. A crafting apparatus assembly comprising:
a crafting apparatus support member including:
a substantially planar body portion having an upper surface, a lower surface, and a side surface connecting the upper surface to the lower surface; and
one or more crafting apparatus interface portions having a boss portion extending from the upper surface of the substantially planar body portion; and
a crafting apparatus supported by the crafting apparatus support member, wherein a lower surface of the crafting apparatus include one or more boss-receiving cavities, wherein the boss portion of the one or more crafting apparatus interface portions is configured to be interfaced with the one or more boss-receiving cavities of the crafting apparatus.

12. The crafting apparatus assembly of claim 11, wherein the crafting apparatus includes a working surface angle that defines a working three dimensional Cartesian coordinate system, wherein the upper surface of the substantially planar body portion defines a non-working three dimensional Cartesian coordinate system that is angularly offset from the working surface angle of the crafting apparatus.

13. The crafting apparatus assembly of claim 11 further comprising a workpiece retainer assembly connected to the upper surface of the substantially planar body portion.

14. The crafting apparatus assembly of claim 11, wherein the workpiece retainer assembly includes:
a pair of rod members including by a first rod member and a second rod member that a spaced apart by a distance for forming a workpiece-material-receiving-gap; and
a pair of bracket members that support the pair of rod members away from the upper surface of the substantially planar body portion at a height, wherein the pair of bracket members include a first bracket member and a second bracket member.

15. The crafting apparatus assembly of claim 11, wherein the lower surface of the substantially planar body portion is configured to be supported by a table.

16. The crafting apparatus assembly of claim 11, wherein the side surface of the substantially planar body portion is configured to be connected to a wall.

17. The crafting apparatus assembly of claim 11, wherein the lower surface of the substantially planar body portion is configured to be supported by a crafting apparatus support member management sub-assembly.

18. The crafting apparatus assembly of claim 17, wherein the crafting apparatus support member management sub-assembly includes:
a pair of leg assemblies defined by a first leg assembly and a second leg assembly.

19. The crafting apparatus assembly of claim 18, wherein the crafting apparatus support member management sub-assembly includes one or more catch basket assemblies connected to one or both of the first leg assembly and the second leg assembly.

20. The crafting apparatus assembly of claim 19, wherein the one or more catch basket assemblies include a body of anti-static material.
